(19) United States
(12) Patent Application Publication
(10) Pub. No.: US 2004/0170121 A1
(43) Pub. Date: Sep. 2, 2004

(54) Apparatus and method for transmitting header information in an ultra wide band communication system

(75) Inventors: Jae-Yoel Kim, Gyeonggi-do (KR); Jong-Hoon Ann, Seoul (KR); Seong-Ill Park, Gyeonggi-do (KR); Sung-Yong Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/789,505

(22) Filed: Feb. 27, 2004

(30) Foreign Application Priority Data
Feb. 28, 2003 (KR) 12845/2003

(51) Int. Cl. H04J 11/00

(52) U.S. Cl. 370/208; 370/479

(57) ABSTRACT

An apparatus and method for transmitting header information in an ultra wide band (UWB) communication system. To protect physical layer header information from errors that may occur during transmission in the UWB communication system, a transmitter transmits the header information after encoding it with an error-correcting code, whereas a receiver decodes the encoded header information with the error-correcting code. This improves the throughput in a wireless network and also decreases the bit error rate.

### PRIORITY

This application claims priority to an application entitled “APPARATUS AND METHOD FOR TRANSMITTING HEADER INFORMATION IN ULTRA WIDE BAND COMMUNICATION SYSTEM”, filed in the Korean Intellectual Property Office on Feb. 28, 2003 and assigned Ser. No. 2003-12845, the contents of which are hereby incorporated by reference.

### BACKGROUND OF THE INVENTION

1. Field of the Invention

The present invention relates generally to an apparatus and method for transmitting header information in an ultra wide band communication system, and more particularly to an apparatus and method for correcting errors in the header information that occur during the transmission thereof.

2. Description of the Related Art

Generally, a wireless communication system employs a cell covered by a base station as a basic geographical unit, and is configured such that a mobile terminal receives a communication service from a base station that controls a cell in which the mobile terminal is located. With the development of the communication industry, various technologies have been proposed for a WPAN (Wireless Personal Area Network) enabling direct communication between mobile terminals, not via repeater equipment such as a base station. The WPAN is a communication network in which its “constituents”, such as a relatively small number of personal terminals or electric home appliances, communicate with each other in a narrow operating range, e.g., less than 10 m, through wireless channels. The WPAN has an ad hoc network structure in which a network is formed or canceled as needed, differently from the backbone network. The WPAN system guarantees seamless data transmission/reception when providing services to peripheral units of a personal computer or audio/video equipment.

Typical WPAN technologies include Bluetooth, WLAN (Wireless Local Area Network), and the like. However, the Bluetooth technology has restrictions in high-speed data transmission, and WLAN products are expensive. A new WPAN system proposed to overcome these problems is a UWB (Ultra Wide Band) communication system.

The capacity of a communication system is generally proportional to both bandwidth and SNR (Signal to Noise Ratio). As a result, it is possible to increase the communication system capacity by increasing the bandwidth or the SNR. Accordingly, the UWB communication system transmits, at high speed, a relatively large amount of data with relatively low power over a relatively wide bandwidth of frequencies in a local area. That is, the UWB communication system is based on a spread characteristic of a pulse, i.e., a property of the pulse that it is very short in the time domain but widely spread in the frequency domain. Accordingly, in the UWB communication system, the transmission frequency band is determined according to the waveform of a pulse. Therefore, it is possible for the UWB communication system to make the periods of transmitted pulse streams very short and also to reduce the density of transmission energy per frequency that is a reference of the noise propagation.

The UWB communication system can perform high-speed data transmission/reception because it uses a very short pulse signal with a high frequency bandwidth. Further, because the UWB communication system transmits signals at baseband directly, without carriers, the UWB communication system does not need a mixer, which reduces the complexity of the system equipment. In addition, for the UWB system frequency characteristics, the UWB frequencies have a wide spread band, so that the UWB system is robust against fading effects even in places where there are many obstacles. The UWB system also has low power consumption because it has a lower density of transmission energy per frequency than noise.

One UWB communication system having the above-described features is a local area wireless communication system, which has been discussed in the IEEE (Institute of Electrical and Electronics Engineers) 802.15.3a standard specifications. For its characteristics, the UWB communication system is targeted to local area wireless communication, and it is expected that the system is applied to home networks, local area radars, or the like. In the UWB communication system, a piconet is used as a basic unit of networking for wireless communication.

FIG. 1 is a block diagram schematically illustrating a piconet of a conventional UWB communication system. As illustrated in FIG. 1, the piconet, as a basic unit of networking in the UWB communication system, includes a PNC (PicoNet Coordinator) 100 and a number of devices including a first device 110, a second device 120, a third device 130, and a fourth device 140. The PNC 100 is one of a number of devices located in the piconet that is appointed at a specific request.

As illustrated in FIG. 1, the piconet coordinator 100 determines various parameters required to control transmission channels between the devices located in the piconet, and provides the parameters to the devices 110, 120, 130, and 140. FIG. 1 illustrates an example where a beacon signal is used to control transmission channels between the devices 110, 120, 130, and 140. The parameters may include values for assigning time or frequency channels for each of the devices 110, 120, 130, and 140.

The devices 110, 120, 130, and 140 may be any devices capable of performing wireless communication. For example, the devices 110, 120, 130, and 140 may include any one of the devices such as a television, a modem, a VTR, a vehicle, etc. The devices 110, 120, 130, and 140 require transmission channels, which are implemented by beacon signals from the piconet coordinator 100, in order to perform wireless communication. In other words, the devices 110, 120, 130, and 140 are assigned time or frequency channels on the basis of parameters provided by the beacon signals from the piconet coordinator 100, and transmit or receive data over the assigned time or frequency channels. Of course, the devices 110, 120, 130, and 140 can transmit or receive to or from the piconet coordinator 100 over the assigned time or frequency channels.

As described above, the piconet has a configuration enabling all the devices, including the piconet coordinator 100, located in the piconet to perform data transmission between them under control of the piconet coordinator 100.

FIG. 2 schematically illustrates an example of the frame structure of each layer in the UWB communication system. More specifically, FIG. 2 illustrates two frames separately: a MAC (Medium Access Control) layer frame produced from a MAC layer, and a PHY (physical) layer frame produced from a PHY layer.

As illustrated in FIG. 2, the MAC layer frame includes a MAC header 210 and a MAC payload+FCS (Frame Check Sequence) 200. The PHY layer frame includes a preamble 260, a PHY header 250, a MAC header 240, an HCS (Header Check Sequence) 230, and a MAC payload+FCS 220. The preamble 260 is generally composed of 160 QPSK (Quadrature Phase Shift Keying) symbols, and is used to synchronize a transmitter and a receiver, the recovery of carrier offset, the equalization of received signals, and the like. The PHY header 250 generally has a length of 2 octets (one octet: 8 bits), and is used to represent information of a scrambling code, a MAC frame's transfer rate, data length, etc. The MAC header 240 has a length of 10 octets, and is used to represent information of a frame control signal, a PNID (PicoNet IDentifier), a DestiID (Destination IDentifier), a SrcID (Source IDentifier), a fragmentation control, and a stream index. The HCS 230 has a length of 2 octets, and is used to detect errors in the PHY header 250 and the MAC header 240. A MAC payload in the MACpayload+FCS 220 has a length of 0˜2048 octets, and is used to transmit transmission-target data, and encryption information. The MAC payload may have any length in the range of 0 to 2048 octets, and thus enables the transmission of a flexible size of the target data and encryption information. An FCS in the MAC payload+FCS 220 has a length of 4 octets, and is used to detect errors in the transmitted data.

FIG. 3 illustrates an example of a device for producing transmission frames in the conventional UWB communication system. As illustrated in FIG. 3, MAC header information 320 produced in the MAC layer is provided to multiplexers 340 and 360, whereas PHY header information 310 produced in the PHY layer is provided to the multiplexer 340 and a multiplexer 370. The multiplexer 340 temporally multiplexes the PHY and MAC header information 310 and 320, and then provides it to a header check sequence generator 350. The header check sequence generator 350 generates a header check sequence according to the MAC and PHY header information. The header check sequence is information for checking whether there is an error in the PHY and MAC header information, which may occur during the transmission.

After being produced by the header check sequence generator 350, the header check sequence is provided to the multiplexer 360 through one input thereof. The payload (i.e., transmission-target information) and the frame check sequence for informing whether an error occurs in the payload are provided to the multiplexer 360 through another input thereof. The payload, the frame check sequence, the MAC header information, and the header check sequence are multiplexed into a single information stream through the multiplexer 360, and then output to a scrambler 380. The scrambler 380 scrambles the multiplexed information stream with a predetermined scrambling code, and outputs it to the multiplexer 370 through one input thereof. A preamble for implementing synchronization, channel estimation and the like is provided to the multiplexer 370 through another input thereof. The multiplexer 370 temporally multiplexes the preamble, the PHY header information, and the scrambled information, and outputs them in a predetermined frame format.

As described above, the conventional UWB communication system uses the header check sequence to protect the PHY header information. However, using the header check sequence, it is only possible to check whether an error occurs, i.e., it is impossible to correct the error. To overcome this problem, the conventional UWB communication system employs a retransmission scheme. In the retransmission scheme, when the UWB communication system fails to receive data due to error occurrence in the PHY header information, the transmitter is requested to retransmit the data. However, use of the retransmission scheme also has a problem in that it lowers the overall network's throughput because it retransmits not only the PHY header information, but also the entire corresponding frame.

### SUMMARY OF THE INVENTION

Therefore, the present invention has been designed in view of the above problem, and it is an object of the present invention to provide an apparatus and method for reliably transmitting and receiving physical layer header information in a UWB (Ultra Wide Band) communication system.

It is another object of the present invention to provide an apparatus and method for encoding 11-bit information for transmission into an encoded symbol stream of 32 symbols.

It is a further object of the present invention to provide an apparatus and method for decoding a transmitted symbol stream encoded with a coding rate of (32, 11).

It is another object of the present invention to provide an apparatus and method for transmitting physical layer header information of a frame after encoding it with an error-correcting code in a UWB communication system.

It is still another object of the present invention to provide an apparatus and method for decoding physical layer header information that was transmitted after being encoded with an error-correcting code in a UWB communication system.

It is a further another object of the present invention to provide a frame structure for transmitting physical layer header information that was encoded with an error-correcting code in a UWB communication system.

It is another object of the present invention to provide an apparatus and method employing a coding scheme based on an error-correcting code to perform error correction of physical layer header information in a UWB communication system.

It is yet another object of the present invention to provide an apparatus and method for encoding physical layer header information on the basis of codes with an optimal minimum distance from among the codes that can be used as error-correcting codes in a UWB communication system.

In accordance with one aspect of the present invention, the above and other objects can be accomplished by an apparatus enabling a transmitter to protect and transmit physical layer header information of respective header information of layers, in an ultra wide band (UWB) communication system in which a plurality of devices having the transmitter constitute a piconet and data transmission between the plurality of devices is performed through a frame having said respective header information of layers, said apparatus comprising: a bit “1” generator for generating a sequence of 1s; a basis Walsh code generator for generating 5 basis Walsh code sequences of length 32; a basis mask sequence generator for generating 5 basis mask sequences of length 32; a plurality of AND elements for receiving all 11 bits of the physical layer header information as their inputs; performing respective AND operations between 5 more significant bits of the 11 bits and the 5 basis Walsh code sequences, performing an AND operation between a sixth bit of the 11 bits and the sequence of 1s, performing respective AND operations between 5 less significant bits of the 11 bits and the 5 basis mask sequences, and outputting 11 encoded symbol sequences of length 32; and an exclusive OR element for performing an exclusive OR operation between the 11 encoded symbol sequences on a symbol-by-symbol basis, and thus outputting a single encoded symbol sequence.

In accordance with another aspect of the present invention, there is provided a method enabling a transmitter to protect and transmit physical layer header information of respective header information of layers, in a UWB communication system in which a plurality of devices having the transmitter constitute a piconet and data transmission between the plurality of devices is performed through a frame having said respective header information of layers, said method comprising the steps of: a) generating a sequence of 1s; b) generating 5 basis Walsh code sequences of length 32; c) generating 5 basis mask sequences of length 32; d) receiving, as inputs, all 11 bits of the physical layer header information; performing respective AND operations between 5 more significant bits of the 11 bits and the 5 basis Walsh code sequences; performing an AND operation between a sixth bit of the 11 bits and the sequence of 1s; performing respective AND operations between 5 less significant bits of the 11 bits and the 5 basis mask sequences; and outputting 11 encoded symbol sequences of length 32; and e) performing an exclusive OR operation between the 11 encoded symbol sequences on a symbol-by-symbol basis, and thus outputting a single encoded symbol sequence.

In accordance with a further aspect of the present invention, there is provided an apparatus decoding in a receiver physical layer header information symbols, which have been encoded with a coding rate of (32, 11) and transmitted through a frame having physical layer header information, in a UWB communication system in which a plurality of devices have the receiver constitute a piconet and data transmission between the plurality of devices is performed through the frame, said apparatus comprising: a mask sequence generator for generating 31 mask sequences, each having an inherent mask sequence index; a plurality of AND elements for receiving the mask sequences and an encoded physical layer header information symbol sequence of length 32 as their inputs; performing AND operations respectively between the mask sequences and the encoded physical layer header information symbol sequence; and outputting physical layer header information symbol sequences from which the mask sequences are removed; a plurality of correlation calculators for receiving, as their inputs, the encoded physical layer header information symbol sequence and the physical layer header information symbol sequences from which the mask sequences are removed; each calculator calculating correlation values respectively between a corresponding one of the symbol sequences and a plurality of bi-orthogonal Walsh codes, each code having an inherent Walsh code index; and each calculator outputting a largest one of the calculated correlation values, a corresponding mask sequence index and a Walsh code index corresponding to the largest correlation value; and a correlation comparator for comparing the correlation values output from the plurality of correlation calculators, respectively; combining together a Walsh code index and a mask sequence index, both corresponding to a largest one of the compared correlation values; and outputting the combined indices as 11-bit physical layer header information.

In accordance with another aspect of the present invention, there is provided a method for decoding in a receiver physical layer header information symbols, which have been encoded with a coding rate of (32,11) and transmitted through a frame having physical layer header information, in a UWB communication system in which a plurality of devices have the receiver constitute a piconet and data transmission between the plurality of devices is performed through the frame, said method comprising the steps of: a) generating 31 mask sequences, each having an inherent mask sequence index; b) receiving, as inputs, the mask sequences and an encoded physical layer header information symbol sequence of length 32; performing AND operations respectively between the mask sequences and the encoded physical layer header information symbol sequence; and outputting physical layer header information symbol sequences from which the mask sequences are removed; c) receiving, as inputs, the encoded physical layer header information symbol sequence and the physical layer header information symbol sequences from which the mask sequences are removed; calculating correlation values respectively between each of the symbol sequences and a plurality of bi-orthogonal Walsh codes, each code having an inherent Walsh code index; and outputting, for each of the symbol sequences, a largest one of the calculated correlation values, a corresponding mask sequence index and a Walsh code index corresponding to the largest correlation value; and d) comparing the output correlation values corresponding respectively to the symbol sequences; combining together a Walsh code index and a mask sequence index, both corresponding to a largest one of the compared correlation values; and outputting the combined indices as 11-bit physical layer header information.

In accordance with still another aspect of the present invention, there is provided an apparatus enabling a transmitter to protect and transmit physical layer header information of respective header information of layers, in a UWB communication system in which a plurality of devices having the transmitter constitute a piconet and data transmission between the plurality of devices is performed through a frame having said respective header information of layers, said apparatus comprising: a bi-orthogonal sequence generator for generating a bi-orthogonal sequence by performing an AND operation between more significant bits of physical layer header information bits and predetermined basis Walsh code sequences; a mask sequence generator for generating a mask sequence by performing an AND operation between less significant bits of the physical layer header information bits and predetermined mask sequences; and an exclusive OR element for performing an exclusive OR operation on a symbol-by-symbol basis between the bi-orthogonal sequence output from the bi-orthogonal sequence generator and the mask sequence output from the mask sequence generator, so as to output a single encoded symbol sequence.

In accordance with yet another aspect of the present invention, there is provided a method for protecting and transmitting by a transmitter physical layer header information of respective header information of layers, in a UWB communication system in which a plurality of devices have the transmitter constitute a piconet and data transmission between the plurality of devices is performed through a frame having said respective header information of layers, said method comprising the steps of: a) generating a bi-orthogonal sequence by performing an AND operation between more significant bits of physical layer header information bits and predetermined basis Walsh code sequences; b) generating a mask sequence by performing an AND operation between less significant bits of the physical layer header information bits and predetermined mask sequences; and c) performing an exclusive OR operation on a symbol-by-symbol basis between the generated bi-orthogonal sequence and the generated mask sequence, so as to output a single encoded symbol sequence.

### BRIEF DESCRIPTION OF THE DRAWINGS

The above and other objects, features, and advantages of the present invention will be more clearly understood from the following detailed description taken in conjunction with the accompanying drawings, in which:

FIG. 1 schematically illustrates a piconet of a conventional UWB (Ultra Wide Band) communication system;

FIG. 2 schematically illustrates an example of the frame structure of each layer in a UWB communication system;

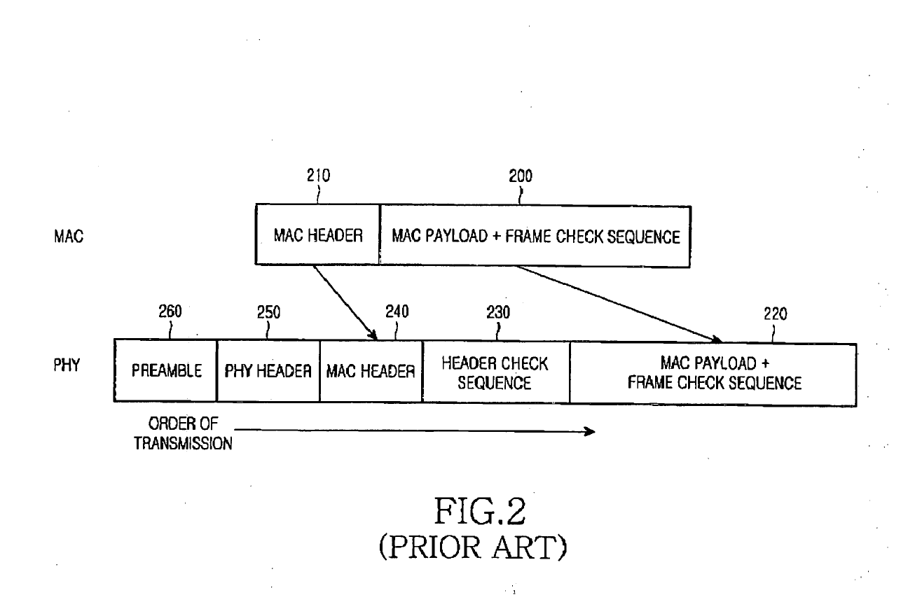

FIG. 3 illustrates an example of a device for producing transmission frames in a conventional UWB communication system;

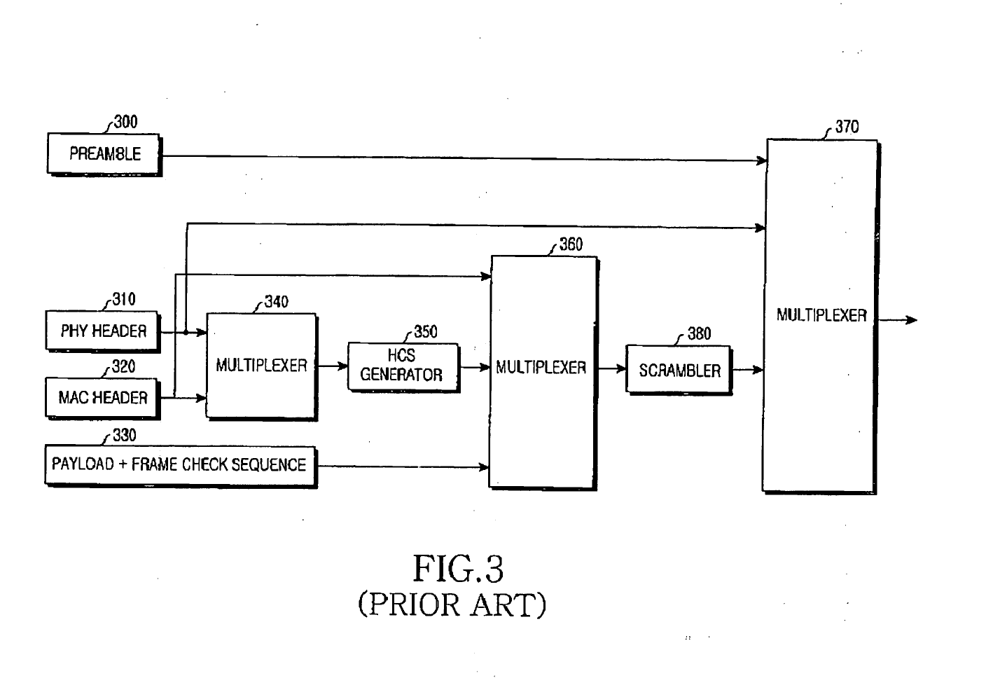

FIG. 4 illustrates the generation of Walsh codes required to realize embodiments of the present invention;

FIG. 5 illustrates the generation of mask sequences required to realize embodiments of the present invention;

FIG. 6 illustrates the frame structure of each layer in a UWB communication system, according to an embodiment of the present invention;

FIG. 7 illustrates an example of a device for producing transmission frames in a transmitter in the UWB communication system, according to an embodiment of the present invention;

FIG. 8 conceptually illustrates an encoder illustrated in FIG. 7;

FIG. 9 illustrates a detailed configuration of the encoder illustrated in FIG. 7;

FIG. 10 illustrates an example of a receiver in a UWB communication system according to an embodiment of the present invention; and

FIG. 11 illustrates a detailed configuration of a decoder illustrated in FIG. 10.

### DETAILED DESCRIPTION OF THE PREFERRED EMBODIMENTS

Preferred embodiments of the present invention will be described in detail herein below with reference to the annexed drawings. The description of the embodiments is provided to embody main components of the present invention, without limiting the present invention. In the following description with reference to the drawings, elements that operate in the same or similar manner are denoted by the same reference numerals even though they are depicted in different drawings.

The present invention proposes a technology for transmitting frame header information, which uses a coding scheme for protecting frame header information, particularly PHY (physical) header information, in a UWB (Ultra Wide Band) communication system. In this regard, a technology for generating an error-correcting code for encoding header information, a technology for encoding header information with the error-correcting code, and a technology for decoding the header information that was encoded and transmitted will be described. The technologies or elements described above will be described separately in the following description of the embodiments according to the present invention.

1. Generation of Error-Correcting Code

A detailed description will now be given of an apparatus and method for generating an error-correcting code for encoding frame header information in a UWB communication system according to an embodiment of the present invention. The following description will be given with reference to an example in which an error-correcting code of length 32 is generated. Accordingly, the header information will be encoded with a coding rate (32, 11) in the embodiment of the present invention.

Generally, Hamming distance distribution of codewords based on error-correcting codes is a measure of the performance of a linear error-correcting code. The Hamming distance is the number of non-zero symbols in each codeword. For example, if a codeword is “0111”, the Hamming distance is “3”, which is the number of is in the codeword “0111”. When there are a plurality of codewords, the minimum value of the respective Hamming distances of the codewords is called a minimum distance (dₘᵢₙ). In the linear error-correcting code, as the minimum distance is larger, the error-correcting performance is higher. Details thereof can be seen in a reference, “The Theory of Error-Correcting Codes”: F. J. MacWilliams and N. J. A. Sloane, North-Holland.

A 2nd-order Reed Muller code that can be used as the error-correcting code can be inferred from a sequence set that is a set of sequences composed of the respective sums of the elements of an m-sequence and the elements of an arbitrary sequence. In order to use the sequence set, whose elements are the sequences obtained from the sums, as the linear error-correcting code, it is better for the sequence set to have a larger minimum distance. Such sequence sets include a Kasami sequence set, a Gold sequence set, a Kerdock sequence set, etc. These sequences have a minimum distance of

$$\frac{{2}^{2 m} - {2}^{m}}{2} ,$$

when the total length L is 2^{2m} (i.e., when the index part is even), whereas the minimum distance is 2^{2m}-2^{m} when the total length L is 2^{2m+1} (i.e., when the index part is odd). For example, if the total length L is 32, the minimum distance is 12.

In the case of a coding rate of (2^{k}, k), the minimum distance dₘᵢₙ of the 1st-order Reed Muller code is 2^{k-1}. However, where the 1st-order Reed Muller code is extended to bi-orthogonal codes, the minimum distance dₘᵢₙ of 2^{k-1} remains unchanged even when the coding rate is changed to (2^{k}, k+1). In the case where the 1st-order Reed Muller code is extended to a 2nd-order Reed Muller code, the coding rate may be changed to (2^{k}, k+1+ₖC₂), as the number of basis codes increases, but the minimum distance dₘᵢₙ is reduced by half, i.e., changed from 2^{k-1} to 2^{k-2}.

Accordingly, the present invention preferably generates an error-correcting code having a good minimum distance by increasing the number of basis codes. In other words, according to the present invention, it is possible to generate error-correcting codes that have minimum distance characteristics better than the conventional 2nd-order Reed Muller codes, and also increase the number of basis codes, compared to the 1st-order Reed Muller codes. Such error-correcting codes have good characteristics also in terms of the coding rate. In the following description, an error-correcting code generated according to the embodiments of the present invention is referred to as a “subcode”.

In coding theory, there is a column permutation function that converts the m-sequence to Walsh codes. If sequences composed of the sum of a specific sequence and an m-sequence are column-permutated by the column permutation function, the m-sequence component becomes Walsh codes. However, the specific sequence component becomes codes that permit the sum with the Walsh codes to have a minimum distance that satisfies the characteristics described above. Hereinafter, they are referred to as “mask sequences”.

With reference to the drawings, a description will now be given of an example in which subcodes of 2nd-order Reed Muller code of length 32 are generated from an m-sequence m₁ and a specific sequence m₂.

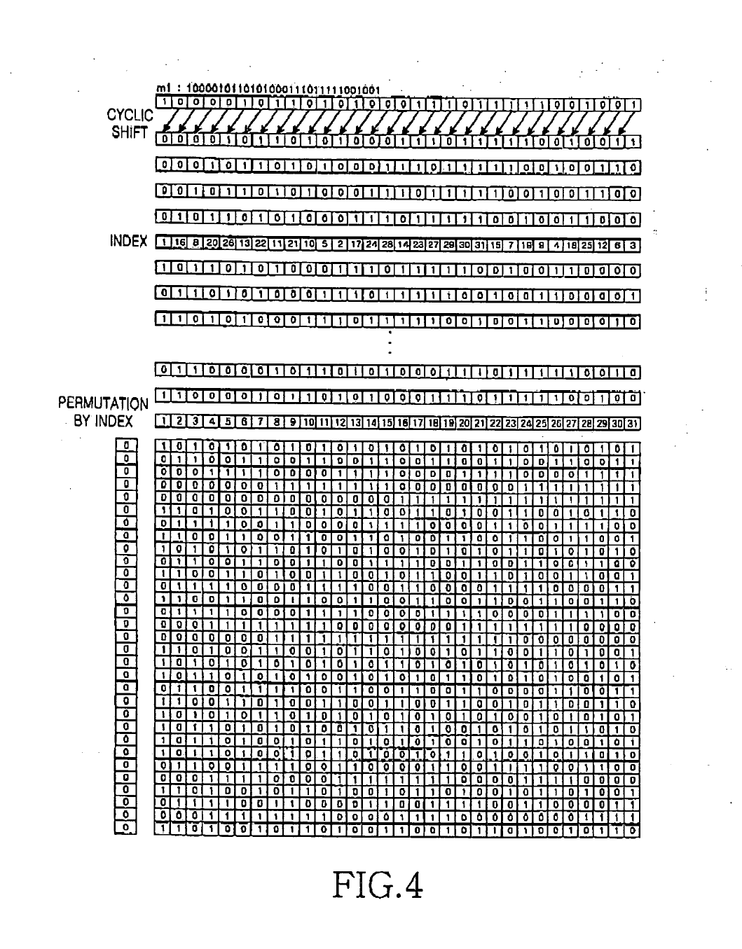

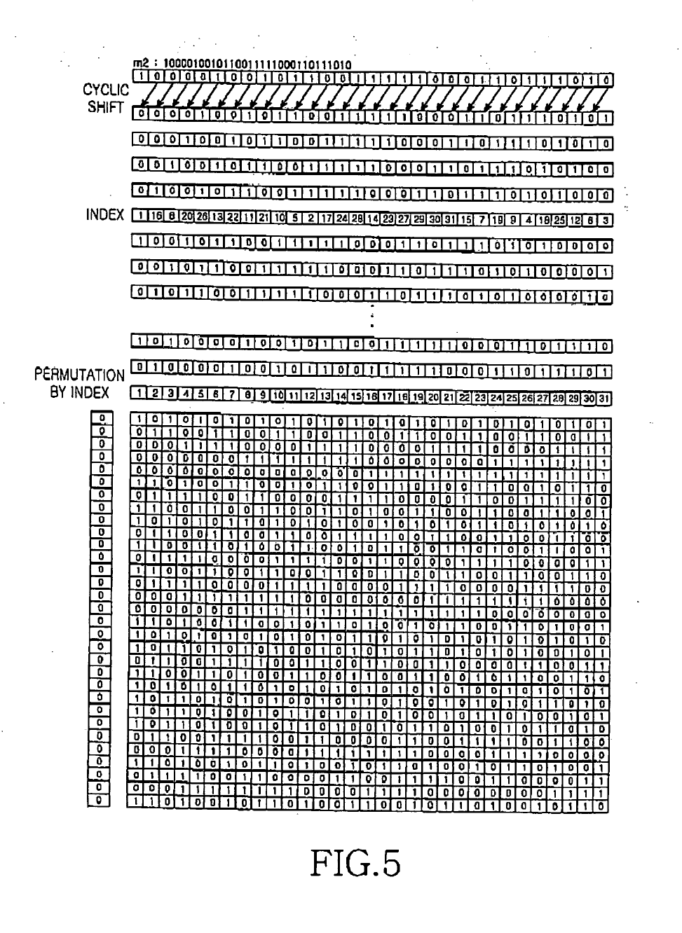

FIG. 4 illustrates an example in which Walsh codes are generated by column permutation of an m-sequence m₁. FIG. 5 illustrates an example in which mask sequences are generated by column permutation of a specific sequence m₂.

Two m-sequences m₁ and m₂, which allow the generation of a Gold sequence, are selected, and then a column permutation function that converts the m-sequence m₁ to Walsh codes is found. The m-sequences m₁ and m₂ become Walsh codes and mask sequences, respectively, by applying the column permutation function to the m-sequences m₁ and m₂. The Gold sequence belongs to sequences whose minimum distance is large, as described above. Accordingly, the generated subcodes, i.e., the Walsh codes and the mask sequences, are suitable for use as error-correcting codes.

In order to generate an error-correcting code having a coding rate of (32, 11), the two m-sequences, which will be converted respectively to Walsh codes and mask sequences by a column permutation function, must be of length 31. Thus, a generator polynomial for generating the m-sequences m₁ and m₂ must be order 5. In other words, only the generator polynomial of order 5 allows the period (or length) to be 2⁵-1, and thus “31”. For example, the generator polynomial may be x⁵+x⁴+x²+x+1 and x⁵+x²+1.

FIG. 4 illustrates an example of a method for generating Walsh codes by applying a column permutation function to an m-sequence m₁ of length (or period) 31 that is generated from the generator polynomial x⁵+x⁴+x²+x+1. It is assumed that the m-sequence m₁ is “1000010110101000111011111001001”.

As illustrated in FIG. 4, the m-sequence m₁ is cyclically shifted left, bit by bit, to generate cyclic sequences. A first cyclic sequence is “0000101101010001110111110010011”, which is generated by cyclically shifting the m-sequence m₁ once. If the first cyclic sequence is cyclically shifted once again, a second cyclic sequence is generated, which is “0001011010100011101111100100110”. In this manner, it is possible to generate 31 different cyclic sequences of length 31, including the m-sequence m₁, by cyclically shifting the m-sequence m₁, bit by bit, sequentially for all 31 bits thereof, as described above. The following table illustrates an example of the cyclic sequences generated in the manner described above.

TABLE 1

| | | | | | | | | | | | | | | | | | | | | |
|---|---|---|---|---|---|---|---|---|---|---|---|---|---|---|---|---|---|---|---|---|
| m1 | 1 | 0 | 0 | 0 | 0 | 1 | 0 | 1 | 1 | 0 | 1 | 0 | 1 | 0 | 0 | 0 | 1 | 1 | 1 | 0 |
| #1 | 0 | 0 | 0 | 0 | 1 | 0 | 1 | 1 | 0 | 1 | 0 | 1 | 0 | 0 | 0 | 1 | 1 | 1 | 0 | 1 |
| #2 | 0 | 0 | 0 | 1 | 0 | 1 | 1 | 0 | 1 | 0 | 1 | 0 | 0 | 0 | 1 | 1 | 1 | 0 | 1 | 1 |
| #3 | 0 | 0 | 1 | 0 | 1 | 1 | 0 | 1 | 0 | 1 | 0 | 0 | 0 | 1 | 1 | 1 | 0 | 1 | 1 | 1 |
| #4 | 0 | 1 | 0 | 1 | 1 | 0 | 1 | 0 | 1 | 0 | 0 | 0 | 1 | 1 | 1 | 0 | 1 | 1 | 1 | 1 |
| #5 | 1 | 0 | 1 | 1 | 0 | 1 | 0 | 1 | 0 | 0 | 0 | 1 | 1 | 1 | 0 | 1 | 1 | 1 | 1 | 1 |
| #6 | 0 | 1 | 1 | 0 | 1 | 0 | 1 | 0 | 0 | 0 | 1 | 1 | 1 | 0 | 1 | 1 | 1 | 1 | 1 | 0 |
| #7 | 1 | 1 | 0 | 1 | 0 | 1 | 0 | 0 | 0 | 1 | 1 | 1 | 0 | 1 | 1 | 1 | 1 | 1 | 0 | 0 |
| #8 | 1 | 0 | 1 | 0 | 1 | 0 | 0 | 0 | 1 | 1 | 1 | 0 | 1 | 1 | 1 | 1 | 1 | 0 | 0 | 1 |
| #9 | 0 | 1 | 0 | 1 | 0 | 0 | 0 | 1 | 1 | 1 | 0 | 1 | 1 | 1 | 1 | 1 | 0 | 0 | 1 | 0 |
| #10 | 1 | 0 | 1 | 0 | 0 | 0 | 1 | 1 | 1 | 0 | 1 | 1 | 1 | 1 | 1 | 0 | 0 | 1 | 0 | 0 |
| #11 | 0 | 1 | 0 | 0 | 0 | 1 | 1 | 1 | 0 | 1 | 1 | 1 | 1 | 1 | 0 | 0 | 1 | 0 | 0 | 1 |
| #12 | 1 | 0 | 0 | 0 | 1 | 1 | 1 | 0 | 1 | 1 | 1 | 1 | 1 | 0 | 0 | 1 | 0 | 0 | 1 | 1 |
| #13 | 0 | 0 | 0 | 1 | 1 | 1 | 0 | 1 | 1 | 1 | 1 | 1 | 0 | 0 | 1 | 0 | 0 | 1 | 1 | 0 |
| #14 | 0 | 0 | 1 | 1 | 1 | 0 | 1 | 1 | 1 | 1 | 1 | 0 | 0 | 1 | 0 | 0 | 1 | 1 | 0 | 0 |
| #15 | 0 | 1 | 1 | 1 | 0 | 1 | 1 | 1 | 1 | 1 | 0 | 0 | 1 | 0 | 0 | 1 | 1 | 0 | 0 | 0 |
| #16 | 1 | 1 | 1 | 0 | 1 | 1 | 1 | 1 | 1 | 0 | 0 | 1 | 0 | 0 | 1 | 1 | 0 | 0 | 0 | 0 |
| #17 | 1 | 1 | 0 | 1 | 1 | 1 | 1 | 1 | 0 | 0 | 1 | 0 | 0 | 1 | 1 | 0 | 0 | 0 | 0 | 1 |
| #18 | 1 | 0 | 1 | 1 | 1 | 1 | 1 | 0 | 0 | 1 | 0 | 0 | 1 | 1 | 0 | 0 | 0 | 0 | 1 | 0 |
| #19 | 0 | 1 | 1 | 1 | 1 | 1 | 0 | 0 | 1 | 0 | 0 | 1 | 1 | 0 | 0 | 0 | 0 | 1 | 0 | 1 |
| #20 | 1 | 1 | 1 | 1 | 1 | 0 | 0 | 1 | 0 | 0 | 1 | 1 | 0 | 0 | 0 | 0 | 1 | 0 | 1 | 1 |
| #21 | 1 | 1 | 1 | 1 | 0 | 0 | 1 | 0 | 0 | 1 | 1 | 0 | 0 | 0 | 0 | 1 | 0 | 1 | 1 | 0 |
| #22 | 1 | 1 | 1 | 0 | 0 | 1 | 0 | 0 | 1 | 1 | 0 | 0 | 0 | 0 | 1 | 0 | 1 | 1 | 0 | 1 |
| #23 | 1 | 1 | 0 | 0 | 1 | 0 | 0 | 1 | 1 | 0 | 0 | 0 | 0 | 1 | 0 | 1 | 1 | 0 | 1 | 0 |
| #24 | 1 | 0 | 0 | 1 | 0 | 0 | 1 | 1 | 0 | 0 | 0 | 0 | 1 | 0 | 1 | 1 | 0 | 1 | 0 | 1 |
| #25 | 0 | 0 | 1 | 0 | 0 | 1 | 1 | 0 | 0 | 0 | 0 | 1 | 0 | 1 | 1 | 0 | 1 | 0 | 1 | 0 |
| #26 | 0 | 1 | 0 | 0 | 1 | 1 | 0 | 0 | 0 | 0 | 1 | 0 | 1 | 1 | 0 | 1 | 0 | 1 | 0 | 0 |
| #27 | 1 | 0 | 0 | 1 | 1 | 0 | 0 | 0 | 0 | 1 | 0 | 1 | 1 | 0 | 1 | 0 | 1 | 0 | 0 | 0 |
| #28 | 0 | 0 | 1 | 1 | 0 | 0 | 0 | 0 | 1 | 0 | 1 | 1 | 0 | 1 | 0 | 1 | 0 | 0 | 0 | 1 |
| #29 | 0 | 1 | 1 | 0 | 0 | 0 | 0 | 1 | 0 | 1 | 1 | 0 | 1 | 0 | 1 | 0 | 0 | 0 | 1 | 1 |
| #30 | 1 | 1 | 0 | 0 | 0 | 0 | 1 | 0 | 1 | 1 | 0 | 1 | 0 | 1 | 0 | 0 | 0 | 1 | 1 | 1 |

| | | | | | | | | | | | |
|---|---|---|---|---|---|---|---|---|---|---|---|
| m1 | 1 | 1 | 1 | 1 | 1 | 0 | 0 | 1 | 0 | 0 | 1 |
| #1 | 1 | 1 | 1 | 1 | 0 | 0 | 1 | 0 | 0 | 1 | 1 |
| #2 | 1 | 1 | 1 | 0 | 0 | 1 | 0 | 0 | 1 | 1 | 0 |
| #3 | 1 | 1 | 0 | 0 | 1 | 0 | 0 | 1 | 1 | 0 | 0 |
| #4 | 1 | 0 | 0 | 1 | 0 | 0 | 1 | 1 | 0 | 0 | 0 |
| #5 | 0 | 0 | 1 | 0 | 0 | 1 | 1 | 0 | 0 | 0 | 0 |
| #6 | 0 | 1 | 0 | 0 | 1 | 1 | 0 | 0 | 0 | 0 | 1 |
| #7 | 1 | 0 | 0 | 1 | 1 | 0 | 0 | 0 | 0 | 1 | 0 |
| #8 | 0 | 0 | 1 | 1 | 0 | 0 | 0 | 0 | 1 | 0 | 1 |
| #9 | 0 | 1 | 1 | 0 | 0 | 0 | 0 | 1 | 0 | 1 | 1 |
| #10 | 1 | 1 | 0 | 0 | 0 | 0 | 1 | 0 | 1 | 1 | 0 |
| #11 | 1 | 0 | 0 | 0 | 0 | 1 | 0 | 1 | 1 | 0 | 1 |
| #12 | 0 | 0 | 0 | 0 | 1 | 0 | 1 | 1 | 0 | 1 | 0 |
| #13 | 0 | 0 | 0 | 1 | 0 | 1 | 1 | 0 | 1 | 0 | 1 |
| #14 | 0 | 0 | 1 | 0 | 1 | 1 | 0 | 1 | 0 | 1 | 0 |
| #15 | 0 | 1 | 0 | 1 | 1 | 0 | 1 | 0 | 1 | 0 | 0 |
| #16 | 1 | 0 | 1 | 1 | 0 | 1 | 0 | 1 | 0 | 0 | 0 |
| #17 | 0 | 1 | 1 | 0 | 1 | 0 | 1 | 0 | 0 | 0 | 1 |
| #18 | 1 | 1 | 0 | 1 | 0 | 1 | 0 | 0 | 0 | 1 | 1 |
| #19 | 1 | 0 | 1 | 0 | 1 | 0 | 0 | 0 | 1 | 1 | 1 |
| #20 | 0 | 1 | 0 | 1 | 0 | 0 | 0 | 1 | 1 | 1 | 0 |
| #21 | 1 | 0 | 1 | 0 | 0 | 0 | 1 | 1 | 1 | 0 | 1 |
| #22 | 0 | 1 | 0 | 0 | 0 | 1 | 1 | 1 | 0 | 1 | 1 |
| #23 | 1 | 0 | 0 | 0 | 1 | 1 | 1 | 0 | 1 | 1 | 1 |
| #24 | 0 | 0 | 0 | 1 | 1 | 1 | 0 | 1 | 1 | 1 | 1 |
| #25 | 0 | 0 | 1 | 1 | 1 | 0 | 1 | 1 | 1 | 1 | 1 |
| #26 | 0 | 1 | 1 | 1 | 0 | 1 | 1 | 1 | 1 | 1 | 0 |
| #27 | 1 | 1 | 1 | 0 | 1 | 1 | 1 | 1 | 1 | 0 | 0 |
| #28 | 1 | 1 | 0 | 1 | 1 | 1 | 1 | 1 | 0 | 0 | 1 |
| #29 | 1 | 0 | 1 | 1 | 1 | 1 | 1 | 0 | 0 | 1 | 0 |
| #30 | 0 | 1 | 1 | 1 | 1 | 1 | 0 | 0 | 1 | 0 | 0 |

“#n” in the table denotes a cyclic sequence generated by cyclically shifting the m-sequence m₁ left n times. The 31 cyclic sequences generated in such a manner are defined as a sequence set. If it is expressed in matrix form, the sequence set is a 31st-order square matrix. One row of the matrix is one sequence. The m-sequence m₁ makes up a first row of the square matrix, and the first cyclic sequence, generated by the first cyclic shift, makes up a second row thereof. That is, the 31 cyclic sequences are arranged in the square matrix in the order in which they are generated. 31 binary sequences, each composed of 5 bits, can be obtained from the 31 columns of the 1st to 5th rows of the square matrix, which correspond to the m-sequence m1 and the 1st to 4th cyclic sequences. The 31 binary sequences can be replaced with 31 decimal numbers, respectively. Bits of the binary sequences shared by the m-sequence m₁ can be regarded as LSBs (Least Significant Bits) of the binary sequences, respectively, whereas bits of the binary sequences shared by the 4th cyclic sequence can be regarded as MSBs (Most Significant Bits) of the binary sequences, respectively. The following table expresses the 31 binary sequences.

TABLE 2

| | | | | | | | | | | | | | | | | | | | | |
|---|---|---|---|---|---|---|---|---|---|---|---|---|---|---|---|---|---|---|---|---|
| m1 | 1 | 0 | 0 | 0 | 0 | 1 | 0 | 1 | 1 | 0 | 1 | 0 | 1 | 0 | 0 | 0 | 1 | 1 | 1 | 0 |
| #1 | 0 | 0 | 0 | 0 | 1 | 0 | 1 | 1 | 0 | 1 | 0 | 1 | 0 | 0 | 0 | 1 | 1 | 1 | 0 | 1 |
| #2 | 0 | 0 | 0 | 1 | 0 | 1 | 1 | 0 | 1 | 0 | 1 | 0 | 0 | 0 | 1 | 1 | 1 | 0 | 1 | 1 |
| #3 | 0 | 0 | 1 | 0 | 1 | 1 | 0 | 1 | 0 | 1 | 0 | 0 | 0 | 1 | 1 | 1 | 0 | 1 | 1 | 1 |
| #4 | 0 | 1 | 0 | 1 | 1 | 0 | 1 | 0 | 1 | 0 | 0 | 0 | 1 | 1 | 1 | 0 | 1 | 1 | 1 | 1 |
| index | 1 | 16 | 8 | 20 | 26 | 13 | 22 | 11 | 21 | 10 | 5 | 2 | 17 | 24 | 28 | 14 | 23 | 27 | 29 | 30 |

| | | | | | | | | | | | |
|---|---|---|---|---|---|---|---|---|---|---|---|
| m1 | 1 | 1 | 1 | 1 | 1 | 0 | 0 | 1 | 0 | 0 | 1 |
| #1 | 1 | 1 | 1 | 1 | 0 | 0 | 1 | 0 | 0 | 1 | 1 |
| #2 | 1 | 1 | 1 | 0 | 0 | 1 | 0 | 0 | 1 | 1 | 0 |
| #3 | 1 | 1 | 0 | 0 | 1 | 0 | 0 | 1 | 1 | 0 | 0 |
| #4 | 1 | 0 | 0 | 1 | 0 | 0 | 1 | 1 | 0 | 0 | 0 |
| index | 31 | 15 | 7 | 19 | 9 | 4 | 18 | 25 | 12 | 6 | 3 |

The 31 decimal numbers, replacing the 31 binary sequences, define column permutation indices, which have values of 1 to 31, respectively. When the column permutation indices are determined, the columns of the square matrix are rearranged according to the respective values of the column permutation indices. In other words, a column of the square matrix, whose index value is 1, is rearranged as the 1st column of a new square matrix after the rearrangement, whereas a column of the square matrix whose index value is 2 is rearranged as the 2nd column of the new square matrix. Accordingly, such rearrangement of the columns of the square matrix produces a new 31st-order square matrix whose columns are arranged according to the respective values of the column permutation indices. It can be understood that if the columns of the above Table 1 are rearranged according to the column permutation indices of the above Table 2, they can be expressed as the following table.

TABLE 3

| | | | | | | | | | | | | | | | | | | | | |
|---|---|---|---|---|---|---|---|---|---|---|---|---|---|---|---|---|---|---|---|---|
| m₁ | 1 | 0 | 1 | 0 | 1 | 0 | 1 | 0 | 1 | 0 | 1 | 0 | 1 | 0 | 1 | 0 | 1 | 0 | 1 | 0 |
| #1 | 0 | 1 | 1 | 0 | 0 | 1 | 1 | 0 | 0 | 1 | 1 | 0 | 0 | 1 | 1 | 0 | 0 | 1 | 1 | 0 |
| #2 | 0 | 0 | 0 | 1 | 1 | 1 | 1 | 0 | 0 | 0 | 0 | 1 | 1 | 1 | 1 | 0 | 0 | 0 | 0 | 1 |
| #3 | 0 | 0 | 0 | 0 | 0 | 0 | 0 | 1 | 1 | 1 | 1 | 1 | 1 | 1 | 1 | 0 | 0 | 0 | 0 | 0 |
| #4 | 0 | 0 | 0 | 0 | 0 | 0 | 0 | 0 | 0 | 0 | 0 | 0 | 0 | 0 | 0 | 1 | 1 | 1 | 1 | 1 |
| #5 | 1 | 1 | 0 | 1 | 0 | 0 | 1 | 1 | 0 | 0 | 1 | 0 | 1 | 1 | 0 | 0 | 1 | 1 | 0 | 1 |
| #6 | 0 | 1 | 1 | 1 | 1 | 0 | 0 | 1 | 1 | 0 | 0 | 0 | 0 | 1 | 1 | 1 | 1 | 0 | 0 | 0 |
| #7 | 1 | 1 | 0 | 0 | 1 | 1 | 0 | 0 | 1 | 1 | 0 | 0 | 1 | 1 | 0 | 1 | 0 | 0 | 1 | 1 |
| #8 | 1 | 0 | 1 | 0 | 1 | 0 | 1 | 1 | 0 | 1 | 0 | 1 | 0 | 1 | 0 | 0 | 1 | 0 | 1 | 0 |
| #9 | 0 | 1 | 1 | 0 | 0 | 1 | 1 | 0 | 0 | 1 | 1 | 0 | 0 | 1 | 1 | 1 | 1 | 0 | 0 | 1 |
| #10 | 1 | 1 | 0 | 0 | 1 | 1 | 0 | 1 | 0 | 0 | 1 | 1 | 0 | 0 | 1 | 0 | 1 | 1 | 0 | 0 |
| #11 | 0 | 1 | 1 | 1 | 1 | 0 | 0 | 0 | 0 | 1 | 1 | 1 | 1 | 0 | 0 | 1 | 1 | 0 | 0 | 0 |
| #12 | 1 | 1 | 0 | 0 | 1 | 1 | 0 | 0 | 1 | 1 | 0 | 0 | 1 | 1 | 0 | 0 | 1 | 1 | 0 | 0 |
| #13 | 0 | 1 | 1 | 1 | 1 | 0 | 0 | 0 | 0 | 1 | 1 | 1 | 1 | 0 | 0 | 0 | 0 | 1 | 1 | 1 |
| #14 | 0 | 0 | 0 | 1 | 1 | 1 | 1 | 1 | 1 | 1 | 1 | 0 | 0 | 0 | 0 | 0 | 0 | 0 | 0 | 1 |
| #15 | 0 | 0 | 0 | 0 | 0 | 0 | 0 | 1 | 1 | 1 | 1 | 1 | 1 | 1 | 1 | 1 | 1 | 1 | 1 | 1 |
| #16 | 1 | 1 | 0 | 1 | 0 | 0 | 1 | 1 | 0 | 0 | 1 | 0 | 1 | 1 | 0 | 1 | 0 | 0 | 1 | 0 |
| #17 | 1 | 0 | 1 | 0 | 1 | 0 | 1 | 0 | 1 | 0 | 1 | 0 | 1 | 0 | 1 | 1 | 0 | 1 | 0 | 1 |
| #18 | 1 | 0 | 1 | 1 | 0 | 1 | 0 | 1 | 0 | 1 | 0 | 0 | 1 | 0 | 1 | 0 | 1 | 0 | 1 | 1 |
| #19 | 0 | 1 | 1 | 0 | 0 | 1 | 1 | 1 | 1 | 0 | 0 | 1 | 1 | 0 | 0 | 1 | 1 | 0 | 0 | 1 |
| #20 | 1 | 1 | 0 | 0 | 1 | 1 | 0 | 1 | 0 | 0 | 1 | 1 | 0 | 0 | 1 | 1 | 0 | 0 | 1 | 1 |
| #21 | 1 | 0 | 1 | 0 | 1 | 0 | 1 | 1 | 0 | 1 | 0 | 1 | 0 | 1 | 0 | 1 | 0 | 1 | 0 | 1 |
| #22 | 1 | 0 | 1 | 1 | 0 | 1 | 0 | 1 | 0 | 1 | 0 | 0 | 1 | 0 | 1 | 1 | 0 | 1 | 0 | 0 |
| #23 | 1 | 0 | 1 | 1 | 0 | 1 | 0 | 0 | 1 | 0 | 1 | 1 | 0 | 1 | 0 | 1 | 0 | 1 | 0 | 0 |
| #24 | 1 | 0 | 1 | 1 | 0 | 1 | 0 | 0 | 1 | 0 | 1 | 1 | 0 | 1 | 0 | 0 | 1 | 0 | 1 | 1 |
| #25 | 0 | 1 | 1 | 0 | 0 | 1 | 1 | 1 | 1 | 0 | 0 | 1 | 1 | 0 | 0 | 0 | 0 | 1 | 1 | 0 |
| #26 | 0 | 0 | 0 | 1 | 1 | 1 | 1 | 0 | 0 | 0 | 0 | 1 | 1 | 1 | 1 | 1 | 1 | 1 | 1 | 0 |
| #27 | 1 | 1 | 0 | 1 | 0 | 0 | 1 | 0 | 1 | 1 | 0 | 1 | 0 | 0 | 1 | 0 | 1 | 1 | 0 | 1 |
| #28 | 0 | 1 | 1 | 1 | 1 | 0 | 0 | 1 | 1 | 0 | 0 | 0 | 0 | 1 | 1 | 0 | 0 | 1 | 1 | 1 |
| #29 | 0 | 0 | 0 | 1 | 1 | 1 | 1 | 1 | 1 | 1 | 1 | 0 | 0 | 0 | 0 | 1 | 1 | 1 | 1 | 0 |
| #30 | 1 | 1 | 0 | 1 | 0 | 0 | 1 | 0 | 1 | 1 | 0 | 1 | 0 | 0 | 1 | 1 | 0 | 0 | 1 | 0 |

| | | | | | | | | | | | |
|---|---|---|---|---|---|---|---|---|---|---|---|
| m₁ | 1 | 0 | 1 | 0 | 1 | 0 | 1 | 0 | 1 | 0 | 1 |
| #1 | 0 | 1 | 1 | 0 | 0 | 1 | 1 | 0 | 0 | 1 | 1 |
| #2 | 1 | 1 | 1 | 0 | 0 | 0 | 0 | 1 | 1 | 1 | 1 |
| #3 | 0 | 0 | 0 | 1 | 1 | 1 | 1 | 1 | 1 | 1 | 1 |
| #4 | 1 | 1 | 1 | 1 | 1 | 1 | 1 | 1 | 1 | 1 | 1 |
| #5 | 0 | 0 | 1 | 1 | 0 | 0 | 1 | 0 | 1 | 1 | 0 |
| #6 | 0 | 1 | 1 | 0 | 0 | 1 | 1 | 1 | 1 | 0 | 0 |
| #7 | 0 | 0 | 1 | 1 | 0 | 0 | 1 | 1 | 0 | 0 | 1 |
| #8 | 1 | 0 | 1 | 1 | 0 | 1 | 0 | 1 | 0 | 1 | 0 |
| #9 | 1 | 0 | 0 | 1 | 1 | 0 | 0 | 1 | 1 | 0 | 0 |
| #10 | 1 | 1 | 0 | 1 | 0 | 0 | 1 | 1 | 0 | 0 | 1 |
| #11 | 0 | 1 | 1 | 1 | 1 | 0 | 0 | 0 | 0 | 1 | 1 |
| #12 | 1 | 1 | 0 | 0 | 1 | 1 | 0 | 0 | 1 | 1 | 0 |
| #13 | 1 | 0 | 0 | 0 | 0 | 1 | 1 | 1 | 1 | 0 | 0 |
| #14 | 1 | 1 | 1 | 1 | 1 | 1 | 1 | 0 | 0 | 0 | 0 |
| #15 | 1 | 1 | 1 | 0 | 0 | 0 | 0 | 0 | 0 | 0 | 0 |
| #16 | 1 | 1 | 0 | 0 | 1 | 1 | 0 | 1 | 0 | 0 | 1 |
| #17 | 0 | 1 | 0 | 1 | 0 | 1 | 0 | 1 | 0 | 1 | 0 |
| #18 | 0 | 1 | 0 | 1 | 0 | 1 | 0 | 0 | 1 | 0 | 1 |
| #19 | 1 | 0 | 0 | 0 | 0 | 1 | 1 | 0 | 0 | 1 | 1 |
| #20 | 0 | 0 | 1 | 0 | 1 | 1 | 0 | 0 | 1 | 1 | 0 |
| #21 | 0 | 1 | 0 | 0 | 1 | 0 | 1 | 0 | 1 | 0 | 1 |
| #22 | 1 | 0 | 1 | 0 | 1 | 0 | 1 | 1 | 0 | 1 | 0 |
| #23 | 1 | 0 | 1 | 1 | 0 | 1 | 0 | 0 | 1 | 0 | 1 |
| #24 | 0 | 1 | 0 | 0 | 1 | 0 | 1 | 1 | 0 | 1 | 0 |
| #25 | 0 | 1 | 1 | 1 | 1 | 0 | 0 | 1 | 1 | 0 | 0 |
| #26 | 0 | 0 | 0 | 1 | 1 | 1 | 1 | 0 | 0 | 0 | 0 |
| #27 | 0 | 0 | 1 | 0 | 1 | 1 | 0 | 1 | 0 | 0 | 1 |
| #28 | 1 | 0 | 0 | 1 | 1 | 0 | 0 | 0 | 0 | 1 | 1 |
| #29 | 0 | 0 | 0 | 0 | 0 | 0 | 0 | 1 | 1 | 1 | 1 |
| #30 | 1 | 1 | 0 | 1 | 0 | 0 | 1 | 0 | 1 | 1 | 0 |

Each row of the new 31st-order square matrix, obtained in this method, makes up the Walsh code described above. In other words, the rows of this matrix are Walsh codes (W₁ to W₃₁) of length 31. The Walsh codes are linear codes. The 1st, 2nd, 3rd, 4th, and 5th rows (W₁, W₂, W₄, W₈, and W₁₆) of the matrix are basis codes of the Walsh codes. That is, combination of the basis codes can represent any row of the matrix (i.e., all the Walsh codes).

If the 31 rows of the square matrix are rearranged taking into consideration the basis codes, they can finally be expressed as the following table.

TABLE 4

| | | | | | | | | | | | | | | | | | | | | |
|---|---|---|---|---|---|---|---|---|---|---|---|---|---|---|---|---|---|---|---|---|
| W1 | 1 | 0 | 1 | 0 | 1 | 0 | 1 | 0 | 1 | 0 | 1 | 0 | 1 | 0 | 1 | 0 | 1 | 0 | 1 | 0 |
| W2 | 0 | 1 | 1 | 0 | 0 | 1 | 1 | 0 | 0 | 1 | 1 | 0 | 0 | 1 | 1 | 0 | 0 | 1 | 1 | 0 |
| W3 | 1 | 1 | 0 | 0 | 1 | 1 | 0 | 0 | 1 | 1 | 0 | 0 | 1 | 1 | 0 | 0 | 1 | 1 | 0 | 0 |
| W4 | 0 | 0 | 0 | 1 | 1 | 1 | 1 | 0 | 0 | 0 | 0 | 1 | 1 | 1 | 1 | 0 | 0 | 0 | 0 | 1 |
| W5 | 1 | 0 | 1 | 1 | 0 | 1 | 0 | 0 | 1 | 0 | 1 | 1 | 0 | 1 | 0 | 0 | 1 | 0 | 1 | 1 |
| W6 | 0 | 1 | 1 | 1 | 1 | 0 | 0 | 0 | 0 | 1 | 1 | 1 | 1 | 0 | 0 | 0 | 0 | 1 | 1 | 1 |
| W7 | 1 | 1 | 0 | 1 | 0 | 0 | 1 | 0 | 1 | 1 | 0 | 1 | 0 | 0 | 1 | 0 | 1 | 1 | 0 | 1 |
| W8 | 0 | 0 | 0 | 0 | 0 | 0 | 0 | 1 | 1 | 1 | 1 | 1 | 1 | 1 | 1 | 0 | 0 | 0 | 0 | 0 |
| W9 | 1 | 0 | 1 | 0 | 1 | 0 | 1 | 1 | 0 | 1 | 0 | 1 | 0 | 1 | 0 | 0 | 1 | 0 | 1 | 0 |
| W10 | 0 | 1 | 1 | 0 | 0 | 1 | 1 | 1 | 1 | 0 | 0 | 1 | 1 | 0 | 0 | 0 | 0 | 1 | 1 | 0 |
| W11 | 1 | 1 | 0 | 0 | 1 | 1 | 0 | 1 | 0 | 0 | 1 | 1 | 0 | 0 | 1 | 0 | 1 | 1 | 0 | 0 |
| W12 | 0 | 0 | 0 | 1 | 1 | 1 | 1 | 1 | 1 | 1 | 1 | 0 | 0 | 0 | 0 | 0 | 0 | 0 | 0 | 1 |
| W13 | 1 | 0 | 1 | 1 | 0 | 1 | 0 | 1 | 0 | 1 | 0 | 0 | 1 | 0 | 1 | 0 | 1 | 0 | 1 | 1 |
| W14 | 1 | 1 | 1 | 1 | 1 | 0 | 0 | 1 | 1 | 0 | 0 | 0 | 0 | 1 | 1 | 0 | 0 | 1 | 1 | 1 |
| W15 | 1 | 1 | 0 | 1 | 0 | 0 | 1 | 1 | 0 | 0 | 1 | 0 | 1 | 1 | 0 | 0 | 1 | 1 | 0 | 1 |
| W16 | 0 | 0 | 0 | 0 | 0 | 0 | 0 | 0 | 0 | 0 | 0 | 0 | 0 | 0 | 0 | 1 | 1 | 1 | 1 | 1 |
| W17 | 1 | 0 | 1 | 0 | 1 | 0 | 1 | 0 | 1 | 0 | 1 | 0 | 1 | 0 | 1 | 1 | 0 | 1 | 0 | 1 |
| W18 | 0 | 1 | 1 | 0 | 0 | 1 | 1 | 0 | 0 | 1 | 1 | 0 | 0 | 1 | 1 | 1 | 1 | 0 | 0 | 1 |
| W19 | 1 | 1 | 0 | 0 | 1 | 1 | 0 | 0 | 1 | 1 | 0 | 0 | 1 | 1 | 0 | 1 | 0 | 0 | 1 | 1 |
| W20 | 0 | 0 | 0 | 1 | 1 | 1 | 1 | 0 | 0 | 0 | 0 | 1 | 1 | 1 | 1 | 1 | 1 | 1 | 1 | 0 |
| W21 | 1 | 0 | 1 | 1 | 0 | 1 | 0 | 0 | 1 | 0 | 1 | 1 | 0 | 1 | 0 | 1 | 0 | 1 | 0 | 0 |
| W22 | 0 | 1 | 1 | 1 | 1 | 0 | 0 | 0 | 0 | 1 | 1 | 1 | 1 | 0 | 0 | 1 | 1 | 0 | 0 | 0 |
| W23 | 1 | 1 | 0 | 1 | 0 | 0 | 1 | 0 | 1 | 1 | 0 | 1 | 0 | 0 | 1 | 1 | 0 | 0 | 1 | 0 |
| W24 | 0 | 0 | 0 | 0 | 0 | 0 | 0 | 1 | 1 | 1 | 1 | 1 | 1 | 1 | 1 | 1 | 1 | 1 | 1 | 1 |
| W25 | 1 | 0 | 1 | 0 | 1 | 0 | 1 | 1 | 0 | 1 | 0 | 1 | 0 | 1 | 0 | 1 | 0 | 1 | 0 | 1 |
| W26 | 0 | 1 | 1 | 0 | 0 | 1 | 1 | 1 | 1 | 0 | 0 | 1 | 1 | 0 | 0 | 1 | 1 | 0 | 0 | 1 |
| W27 | 1 | 1 | 0 | 0 | 1 | 1 | 0 | 1 | 0 | 0 | 1 | 1 | 0 | 0 | 1 | 1 | 0 | 0 | 1 | 1 |
| W28 | 0 | 0 | 0 | 1 | 1 | 1 | 1 | 1 | 1 | 1 | 1 | 0 | 0 | 0 | 0 | 1 | 1 | 1 | 1 | 0 |
| W29 | 1 | 0 | 1 | 1 | 0 | 1 | 0 | 1 | 0 | 1 | 0 | 0 | 1 | 0 | 1 | 1 | 0 | 1 | 0 | 0 |
| W30 | 0 | 1 | 1 | 1 | 1 | 0 | 0 | 1 | 1 | 0 | 0 | 0 | 0 | 1 | 1 | 1 | 1 | 0 | 0 | 0 |
| W31 | 1 | 1 | 0 | 1 | 0 | 0 | 1 | 1 | 0 | 0 | 1 | 0 | 1 | 1 | 0 | 1 | 0 | 0 | 1 | 0 |

| | | | | | | | | | | | |
|---|---|---|---|---|---|---|---|---|---|---|---|
| W1 | 1 | 0 | 1 | 0 | 1 | 0 | 1 | 0 | 1 | 0 | 1 |
| W2 | 0 | 1 | 1 | 0 | 0 | 1 | 1 | 0 | 0 | 1 | 1 |
| W3 | 1 | 1 | 0 | 0 | 1 | 1 | 0 | 0 | 1 | 1 | 0 |
| W4 | 1 | 1 | 1 | 0 | 0 | 0 | 0 | 1 | 1 | 1 | 1 |
| W5 | 0 | 1 | 0 | 0 | 1 | 0 | 1 | 1 | 0 | 1 | 0 |
| W6 | 1 | 0 | 0 | 0 | 0 | 1 | 1 | 1 | 1 | 0 | 0 |
| W7 | 0 | 0 | 1 | 0 | 1 | 1 | 0 | 1 | 0 | 0 | 1 |
| W8 | 0 | 0 | 0 | 1 | 1 | 1 | 1 | 1 | 1 | 1 | 1 |
| W9 | 1 | 0 | 1 | 1 | 0 | 1 | 0 | 1 | 0 | 1 | 0 |
| W10 | 0 | 1 | 1 | 1 | 1 | 0 | 0 | 1 | 1 | 0 | 0 |
| W11 | 1 | 1 | 0 | 1 | 0 | 0 | 1 | 1 | 0 | 0 | 1 |
| W12 | 1 | 1 | 1 | 1 | 1 | 1 | 1 | 0 | 0 | 0 | 0 |
| W13 | 0 | 1 | 0 | 1 | 0 | 1 | 0 | 0 | 1 | 0 | 1 |
| W14 | 1 | 0 | 0 | 1 | 1 | 0 | 0 | 0 | 0 | 1 | 1 |
| W15 | 0 | 0 | 1 | 1 | 0 | 0 | 1 | 0 | 1 | 1 | 0 |
| W16 | 1 | 1 | 1 | 1 | 1 | 1 | 1 | 1 | 1 | 1 | 1 |
| W17 | 0 | 1 | 0 | 1 | 0 | 1 | 0 | 1 | 0 | 1 | 0 |
| W18 | 1 | 0 | 0 | 1 | 1 | 0 | 0 | 1 | 1 | 0 | 0 |
| W19 | 0 | 0 | 1 | 1 | 0 | 0 | 1 | 1 | 0 | 0 | 1 |
| W20 | 0 | 0 | 0 | 1 | 1 | 1 | 1 | 0 | 0 | 0 | 0 |
| W21 | 1 | 0 | 1 | 1 | 0 | 1 | 0 | 0 | 1 | 0 | 1 |
| W22 | 0 | 1 | 1 | 1 | 1 | 0 | 0 | 0 | 0 | 1 | 1 |
| W23 | 1 | 1 | 0 | 1 | 0 | 0 | 1 | 0 | 1 | 1 | 0 |
| W24 | 1 | 1 | 1 | 0 | 0 | 0 | 0 | 0 | 0 | 0 | 0 |
| W25 | 0 | 1 | 0 | 0 | 1 | 0 | 1 | 0 | 1 | 0 | 1 |
| W26 | 1 | 0 | 0 | 0 | 0 | 1 | 1 | 0 | 0 | 1 | 1 |
| W27 | 0 | 0 | 1 | 0 | 1 | 1 | 0 | 0 | 1 | 1 | 0 |
| W28 | 0 | 0 | 0 | 0 | 0 | 0 | 0 | 1 | 1 | 1 | 1 |
| W29 | 1 | 0 | 1 | 0 | 1 | 0 | 1 | 1 | 0 | 1 | 0 |
| W30 | 0 | 1 | 1 | 0 | 0 | 1 | 1 | 1 | 1 | 0 | 0 |
| W31 | 1 | 1 | 0 | 0 | 1 | 1 | 0 | 1 | 0 | 0 | 1 |

If a column of length 31, whose elements are all “0”, is inserted before the 1st column of the newly obtained square matrix, then it becomes a matrix of 31 rows and 32 columns. The 1st to 31st rows of this matrix are the 1st to 31st Walsh codes (W₁ to W₃₁) of length 32, respectively.

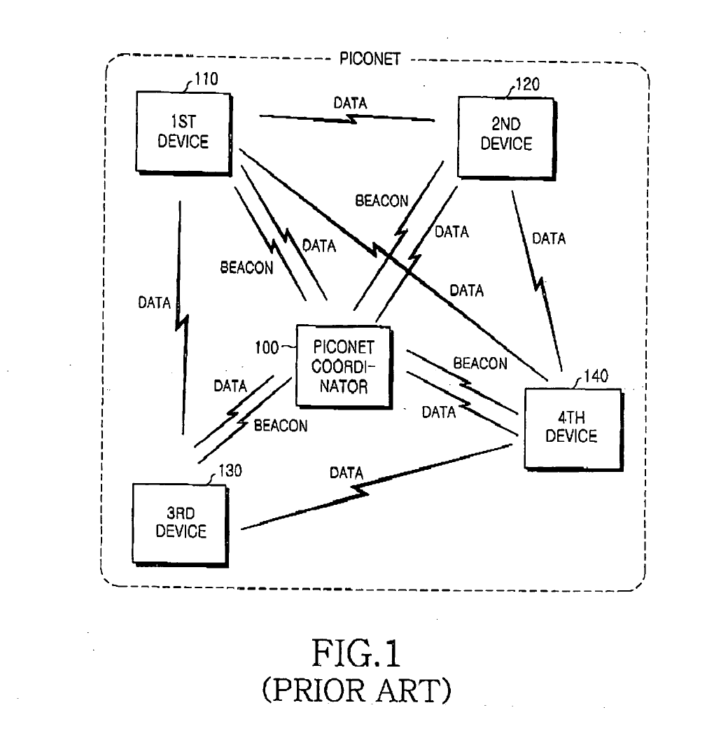

Alternatively, FIG. 5 illustrates an example of a method for generating mask sequences by applying a column permutation function to an m-sequence m₂ of length (or period) 31 that is generated from a generator polynomial x⁵+x²+1. It is assumed in FIG. 1 that the m-sequence m₂ is “1000010010110011111000110111010”.

As illustrated in FIG. 5, the m-sequence m₂ is cyclically shifted left, bit by bit, to generate cyclic sequences. A first cyclic sequence is “0000100101100111110001101110101”, which is generated by cyclically shifting the m-sequence m₂ once. If the first cyclic sequence is cyclically shifted once again, a second cyclic sequence is generated, which is “0001001011001111100011011101010”. As a result, it is possible to generate 31 different cyclic sequences of length 31, including the m-sequence m₂, by cyclically shifting the m-sequence m₂, bit by bit, sequentially for all 31 bits thereof, as described above. The 31 cyclic sequences generated in such a manner are defined as a sequence set. If the sequence set is expressed in matrix form, it is a 31st-order square matrix. One row of the matrix is one sequence. The m-sequence m₂ makes up a first row of the square matrix, and the first cyclic sequence, generated by the first cyclic shift, makes up a second row thereof. That is, the 31 cyclic sequences are arranged in the square matrix in the order in which they are generated. The generated 31st-order square matrix can be expressed as the following table.

TABLE 5

| | | | | | | | | | | | | | | | | | | | | |
|---|---|---|---|---|---|---|---|---|---|---|---|---|---|---|---|---|---|---|---|---|
| m₂ | 1 | 0 | 0 | 0 | 0 | 1 | 0 | 0 | 1 | 0 | 1 | 1 | 0 | 0 | 1 | 1 | 1 | 1 | 1 | 0 |
| #1 | 0 | 0 | 0 | 0 | 1 | 0 | 0 | 1 | 0 | 1 | 1 | 0 | 0 | 1 | 1 | 1 | 1 | 1 | 0 | 0 |
| #2 | 0 | 0 | 0 | 1 | 0 | 0 | 1 | 0 | 1 | 1 | 0 | 0 | 1 | 1 | 1 | 1 | 1 | 0 | 0 | 0 |
| #3 | 0 | 0 | 1 | 0 | 0 | 1 | 0 | 1 | 1 | 0 | 0 | 1 | 1 | 1 | 1 | 1 | 0 | 0 | 0 | 1 |
| #4 | 0 | 1 | 0 | 0 | 1 | 0 | 1 | 1 | 0 | 0 | 1 | 1 | 1 | 1 | 1 | 0 | 0 | 0 | 1 | 1 |
| #5 | 1 | 0 | 0 | 1 | 0 | 1 | 1 | 0 | 0 | 1 | 1 | 1 | 1 | 1 | 0 | 0 | 0 | 1 | 1 | 0 |
| #6 | 0 | 0 | 1 | 0 | 1 | 1 | 0 | 0 | 1 | 1 | 1 | 1 | 1 | 0 | 0 | 0 | 1 | 1 | 0 | 1 |
| #7 | 0 | 1 | 0 | 1 | 1 | 0 | 0 | 1 | 1 | 1 | 1 | 1 | 0 | 0 | 0 | 1 | 1 | 0 | 1 | 1 |
| #8 | 1 | 0 | 1 | 1 | 0 | 0 | 1 | 1 | 1 | 1 | 1 | 0 | 0 | 0 | 1 | 1 | 0 | 1 | 1 | 1 |
| #9 | 0 | 1 | 1 | 0 | 0 | 1 | 1 | 1 | 1 | 1 | 0 | 0 | 0 | 1 | 1 | 0 | 1 | 1 | 1 | 0 |
| #10 | 1 | 1 | 0 | 0 | 1 | 1 | 1 | 1 | 1 | 0 | 0 | 0 | 1 | 1 | 0 | 1 | 1 | 1 | 0 | 1 |
| #11 | 1 | 0 | 0 | 1 | 1 | 1 | 1 | 1 | 0 | 0 | 0 | 1 | 1 | 0 | 1 | 1 | 1 | 0 | 1 | 0 |
| #12 | 0 | 0 | 1 | 1 | 1 | 1 | 1 | 0 | 0 | 0 | 1 | 1 | 0 | 1 | 1 | 1 | 0 | 1 | 0 | 1 |
| #13 | 0 | 1 | 1 | 1 | 1 | 1 | 0 | 0 | 0 | 1 | 1 | 0 | 1 | 1 | 1 | 0 | 1 | 0 | 1 | 0 |
| #14 | 1 | 1 | 1 | 1 | 1 | 0 | 0 | 0 | 1 | 1 | 0 | 1 | 1 | 1 | 0 | 1 | 0 | 1 | 0 | 0 |
| #15 | 1 | 1 | 1 | 1 | 0 | 0 | 0 | 1 | 1 | 0 | 1 | 1 | 1 | 0 | 1 | 0 | 1 | 0 | 0 | 0 |
| #16 | 1 | 1 | 1 | 0 | 0 | 0 | 1 | 1 | 0 | 1 | 1 | 1 | 0 | 1 | 1 | 0 | 1 | 0 | 0 | 0 |
| #17 | 1 | 1 | 0 | 0 | 0 | 1 | 1 | 0 | 1 | 1 | 1 | 0 | 1 | 0 | 1 | 0 | 0 | 0 | 0 | 1 |
| #18 | 1 | 0 | 0 | 0 | 1 | 1 | 0 | 1 | 1 | 1 | 0 | 1 | 0 | 1 | 0 | 0 | 0 | 0 | 1 | 0 |
| #19 | 0 | 0 | 0 | 1 | 1 | 0 | 1 | 1 | 1 | 0 | 1 | 0 | 1 | 0 | 0 | 0 | 0 | 1 | 0 | 0 |
| #20 | 0 | 0 | 1 | 1 | 0 | 1 | 1 | 1 | 0 | 1 | 0 | 1 | 0 | 0 | 0 | 0 | 1 | 0 | 0 | 1 |
| #21 | 0 | 1 | 1 | 0 | 1 | 1 | 1 | 0 | 1 | 0 | 1 | 0 | 0 | 0 | 0 | 1 | 0 | 0 | 1 | 0 |
| #22 | 1 | 1 | 0 | 1 | 1 | 1 | 0 | 1 | 0 | 1 | 0 | 0 | 0 | 0 | 1 | 0 | 0 | 1 | 0 | 1 |
| #23 | 1 | 0 | 1 | 1 | 1 | 0 | 1 | 0 | 1 | 0 | 0 | 0 | 0 | 1 | 0 | 0 | 1 | 0 | 1 | 1 |
| #24 | 0 | 1 | 1 | 1 | 0 | 1 | 0 | 1 | 0 | 0 | 0 | 0 | 1 | 0 | 0 | 1 | 0 | 1 | 1 | 0 |
| #25 | 1 | 1 | 1 | 0 | 1 | 0 | 1 | 0 | 0 | 0 | 0 | 1 | 0 | 0 | 1 | 0 | 1 | 1 | 0 | 0 |
| #26 | 1 | 1 | 0 | 1 | 0 | 1 | 0 | 0 | 0 | 0 | 1 | 0 | 0 | 1 | 0 | 1 | 1 | 0 | 0 | 1 |
| #27 | 1 | 0 | 1 | 0 | 1 | 0 | 0 | 0 | 0 | 1 | 0 | 0 | 1 | 0 | 1 | 1 | 0 | 0 | 1 | 1 |
| #28 | 0 | 1 | 0 | 1 | 0 | 0 | 0 | 0 | 1 | 0 | 0 | 1 | 0 | 1 | 1 | 0 | 0 | 1 | 1 | 1 |
| #29 | 1 | 0 | 1 | 0 | 0 | 0 | 0 | 1 | 0 | 0 | 1 | 0 | 1 | 1 | 0 | 0 | 1 | 1 | 1 | 1 |
| #30 | 0 | 1 | 0 | 0 | 0 | 0 | 1 | 0 | 0 | 1 | 0 | 1 | 1 | 0 | 0 | 1 | 1 | 1 | 1 | 1 |

| | | | | | | | | | | | |
|---|---|---|---|---|---|---|---|---|---|---|---|
| m₂ | 0 | 0 | 1 | 1 | 0 | 1 | 1 | 1 | 0 | 1 | 0 |
| #1 | 0 | 1 | 1 | 0 | 1 | 1 | 1 | 0 | 1 | 0 | 1 |
| #2 | 1 | 1 | 0 | 1 | 1 | 1 | 0 | 1 | 0 | 1 | 0 |
| #3 | 1 | 0 | 1 | 1 | 1 | 0 | 1 | 0 | 1 | 0 | 0 |
| #4 | 0 | 1 | 1 | 1 | 0 | 1 | 0 | 1 | 0 | 0 | 0 |
| #5 | 1 | 1 | 1 | 0 | 1 | 0 | 1 | 0 | 0 | 0 | 0 |
| #6 | 1 | 1 | 0 | 1 | 0 | 1 | 0 | 0 | 0 | 0 | 1 |
| #7 | 1 | 0 | 1 | 0 | 1 | 0 | 0 | 0 | 0 | 1 | 0 |
| #8 | 0 | 1 | 0 | 1 | 0 | 0 | 0 | 0 | 1 | 0 | 0 |
| #9 | 1 | 0 | 1 | 0 | 0 | 0 | 0 | 1 | 0 | 0 | 1 |
| #10 | 0 | 1 | 0 | 0 | 0 | 0 | 1 | 0 | 0 | 1 | 0 |
| #11 | 1 | 0 | 0 | 0 | 0 | 1 | 0 | 0 | 1 | 0 | 1 |
| #12 | 0 | 0 | 0 | 0 | 1 | 0 | 0 | 1 | 0 | 1 | 1 |
| #13 | 0 | 0 | 0 | 1 | 0 | 0 | 1 | 0 | 1 | 1 | 0 |
| #14 | 0 | 0 | 1 | 0 | 0 | 1 | 0 | 1 | 1 | 0 | 0 |
| #15 | 0 | 1 | 0 | 0 | 1 | 0 | 1 | 1 | 0 | 0 | 1 |
| #16 | 0 | 1 | 0 | 1 | 0 | 1 | 1 | 0 | 0 | 1 | 1 |
| #17 | 0 | 0 | 1 | 0 | 1 | 1 | 0 | 0 | 1 | 1 | 1 |
| #18 | 0 | 1 | 0 | 1 | 1 | 0 | 0 | 1 | 1 | 1 | 1 |
| #19 | 1 | 0 | 1 | 1 | 0 | 0 | 1 | 1 | 1 | 1 | 1 |
| #20 | 0 | 1 | 1 | 0 | 0 | 1 | 1 | 1 | 1 | 1 | 0 |
| #21 | 1 | 1 | 0 | 0 | 1 | 1 | 1 | 1 | 1 | 0 | 0 |
| #22 | 1 | 0 | 0 | 1 | 1 | 1 | 1 | 1 | 0 | 0 | 0 |
| #23 | 0 | 0 | 1 | 1 | 1 | 1 | 1 | 0 | 0 | 0 | 1 |
| #24 | 0 | 1 | 1 | 1 | 1 | 1 | 0 | 0 | 0 | 1 | 1 |
| #25 | 1 | 1 | 1 | 1 | 1 | 0 | 0 | 0 | 1 | 1 | 0 |
| #26 | 1 | 1 | 1 | 1 | 0 | 0 | 0 | 1 | 1 | 0 | 1 |
| #27 | 1 | 1 | 1 | 0 | 0 | 0 | 1 | 1 | 0 | 1 | 1 |
| #28 | 1 | 1 | 0 | 0 | 0 | 1 | 1 | 0 | 1 | 1 | 1 |
| #29 | 1 | 0 | 0 | 0 | 1 | 1 | 0 | 1 | 1 | 1 | 0 |
| #30 | 0 | 0 | 0 | 1 | 1 | 0 | 1 | 1 | 1 | 0 | 1 |

The columns of the square matrix are rearranged according to the respective values of the column permutation indices (illustrated above in Table 2) of the m-sequence m₁ used for generating the Walsh codes. In other words, a column of the square matrix, whose index value is 1, is rearranged as the 1st column of a new square matrix after the rearrangement, whereas a column of the square matrix whose index value is 2 is rearranged as the 2nd column of the new square matrix. Accordingly, such rearrangement of the columns of the square matrix produces a new 31st-order square matrix whose columns are arranged according to the values of the column permutation indices. Such a square matrix, obtained by the column permutation according to the column permutation indices, can be expressed as in Table 6.

TABLE 6

| | | | | | | | | | | | | | | | | | | | | |
|---|---|---|---|---|---|---|---|---|---|---|---|---|---|---|---|---|---|---|---|---|
| m₂ | 1 | 1 | 0 | 1 | 1 | 1 | 1 | 0 | 0 | 0 | 0 | 0 | 1 | 1 | 0 | 0 | 0 | 1 | 1 | 0 |
| #1 | 0 | 0 | 1 | 1 | 1 | 0 | 1 | 0 | 1 | 1 | 1 | 1 | 0 | 1 | 1 | 0 | 0 | 1 | 0 | 0 |
| #2 | 0 | 0 | 0 | 1 | 0 | 1 | 0 | 0 | 1 | 1 | 0 | 0 | 0 | 1 | 1 | 0 | 1 | 0 | 1 | 1 |
| #3 | 0 | 1 | 0 | 0 | 0 | 0 | 1 | 1 | 1 | 0 | 1 | 1 | 1 | 1 | 0 | 0 | 1 | 1 | 1 | 0 |
| #4 | 0 | 1 | 0 | 1 | 1 | 0 | 1 | 0 | 0 | 0 | 1 | 0 | 0 | 0 | 1 | 1 | 1 | 0 | 1 | 0 |
| #5 | 1 | 1 | 0 | 0 | 1 | 0 | 1 | 0 | 1 | 1 | 0 | 0 | 1 | 0 | 1 | 0 | 1 | 1 | 0 | 1 |
| #6 | 0 | 1 | 1 | 1 | 1 | 0 | 0 | 1 | 0 | 1 | 0 | 0 | 1 | 0 | 1 | 0 | 1 | 0 | 1 | 0 |
| #7 | 0 | 1 | 0 | 0 | 1 | 1 | 1 | 0 | 1 | 1 | 1 | 0 | 0 | 1 | 0 | 1 | 0 | 0 | 0 | 1 |
| #8 | 1 | 0 | 0 | 0 | 1 | 0 | 0 | 1 | 0 | 1 | 1 | 1 | 0 | 1 | 1 | 0 | 0 | 0 | 1 | 1 |
| #9 | 0 | 0 | 1 | 0 | 0 | 0 | 1 | 1 | 0 | 1 | 1 | 0 | 1 | 0 | 0 | 1 | 0 | 0 | 0 | 0 |
| #10 | 1 | 0 | 0 | 0 | 0 | 1 | 0 | 0 | 0 | 0 | 1 | 0 | 1 | 1 | 1 | 1 | 1 | 1 | 0 | 0 |
| #11 | 1 | 1 | 1 | 1 | 0 | 0 | 0 | 0 | 0 | 0 | 1 | 1 | 1 | 1 | 0 | 0 | 1 | 0 | 0 | 1 |
| #12 | 0 | 1 | 1 | 0 | 1 | 1 | 0 | 1 | 1 | 0 | 0 | 0 | 1 | 1 | 0 | 0 | 0 | 0 | 0 | 1 |
| #13 | 0 | 0 | 0 | 0 | 1 | 1 | 0 | 1 | 0 | 1 | 0 | 1 | 1 | 0 | 0 | 1 | 1 | 1 | 1 | 1 |
| #14 | 1 | 1 | 0 | 1 | 0 | 0 | 1 | 1 | 0 | 1 | 0 | 1 | 0 | 1 | 0 | 1 | 1 | 0 | 0 | 1 |
| #15 | 1 | 1 | 1 | 0 | 1 | 0 | 0 | 1 | 1 | 0 | 1 | 0 | 0 | 0 | 1 | 1 | 1 | 1 | 0 | 1 |
| #16 | 1 | 1 | 1 | 1 | 1 | 1 | 0 | 1 | 0 | 1 | 1 | 0 | 0 | 1 | 0 | 1 | 0 | 1 | 1 | 0 |
| #17 | 1 | 0 | 1 | 1 | 1 | 1 | 1 | 0 | 1 | 1 | 0 | 1 | 1 | 0 | 0 | 1 | 1 | 0 | 0 | 0 |
| #18 | 1 | 1 | 1 | 0 | 0 | 1 | 0 | 0 | 1 | 1 | 1 | 1 | 1 | 0 | 1 | 0 | 0 | 0 | 1 | 0 |
| #19 | 0 | 0 | 1 | 0 | 1 | 1 | 1 | 0 | 0 | 0 | 1 | 1 | 0 | 0 | 0 | 0 | 1 | 1 | 1 | 1 |
| #20 | 0 | 1 | 0 | 1 | 0 | 1 | 1 | 1 | 0 | 1 | 1 | 1 | 1 | 0 | 1 | 0 | 0 | 1 | 0 | 1 |
| #21 | 0 | 0 | 0 | 1 | 1 | 0 | 0 | 1 | 1 | 0 | 0 | 1 | 1 | 1 | 1 | 1 | 0 | 1 | 0 | 0 |
| #22 | 1 | 0 | 0 | 1 | 0 | 0 | 0 | 0 | 1 | 1 | 1 | 0 | 1 | 0 | 0 | 1 | 0 | 1 | 1 | 1 |
| #23 | 1 | 0 | 1 | 1 | 0 | 0 | 1 | 1 | 1 | 0 | 0 | 0 | 0 | 0 | 0 | 0 | 0 | 1 | 1 | 1 |
| #24 | 0 | 0 | 1 | 1 | 0 | 1 | 1 | 1 | 1 | 0 | 1 | 0 | 1 | 1 | 1 | 1 | 1 | 0 | 1 | 1 |
| #25 | 1 | 1 | 0 | 0 | 0 | 1 | 1 | 1 | 1 | 0 | 0 | 1 | 0 | 0 | 1 | 1 | 0 | 0 | 1 | 0 |
| #26 | 1 | 0 | 1 | 0 | 1 | 0 | 1 | 0 | 0 | 0 | 0 | 1 | 1 | 1 | 1 | 1 | 0 | 0 | 1 | 1 |
| #27 | 1 | 0 | 1 | 0 | 0 | 1 | 1 | 1 | 0 | 1 | 0 | 0 | 0 | 1 | 1 | 0 | 1 | 1 | 0 | 0 |
| #28 | 0 | 1 | 1 | 1 | 0 | 1 | 0 | 0 | 0 | 0 | 0 | 1 | 0 | 0 | 1 | 1 | 0 | 1 | 0 | 1 |
| #29 | 1 | 0 | 0 | 1 | 1 | 1 | 0 | 1 | 1 | 0 | 1 | 1 | 0 | 0 | 0 | 0 | 1 | 0 | 0 | 0 |
| #30 | 0 | 1 | 1 | 0 | 0 | 0 | 0 | 0 | 1 | 1 | 0 | 1 | 0 | 1 | 0 | 1 | 1 | 1 | 1 | 0 |

| | | | | | | | | | | | |
|---|---|---|---|---|---|---|---|---|---|---|---|
| m₂ | 1 | 0 | 1 | 0 | 1 | 0 | 1 | 1 | 1 | 0 | 0 |
| #1 | 0 | 0 | 1 | 1 | 0 | 1 | 1 | 1 | 0 | 0 | 0 |
| #2 | 1 | 1 | 1 | 1 | 1 | 0 | 0 | 1 | 0 | 0 | 1 |
| #3 | 1 | 0 | 0 | 1 | 0 | 0 | 0 | 1 | 0 | 1 | 1 |
| #4 | 0 | 1 | 0 | 1 | 1 | 1 | 0 | 1 | 1 | 1 | 0 |
| #5 | 0 | 1 | 0 | 1 | 0 | 0 | 1 | 0 | 1 | 0 | 1 |
| #6 | 1 | 0 | 1 | 0 | 0 | 1 | 1 | 0 | 0 | 1 | 1 |
| #7 | 1 | 0 | 1 | 0 | 0 | 1 | 0 | 0 | 1 | 1 | 1 |
| #8 | 1 | 1 | 0 | 0 | 0 | 0 | 1 | 1 | 1 | 1 | 0 |
| #9 | 1 | 1 | 1 | 1 | 1 | 0 | 1 | 1 | 1 | 0 | 1 |
| #10 | 1 | 1 | 1 | 1 | 0 | 1 | 1 | 0 | 0 | 1 | 0 |
| #11 | 0 | 1 | 1 | 0 | 0 | 1 | 0 | 1 | 1 | 0 | 1 |
| #12 | 0 | 1 | 0 | 1 | 1 | 1 | 1 | 1 | 0 | 1 | 0 |
| #13 | 0 | 0 | 1 | 1 | 0 | 1 | 0 | 1 | 1 | 0 | 0 |
| #14 | 1 | 0 | 0 | 1 | 1 | 1 | 1 | 0 | 0 | 0 | 0 |
| #15 | 1 | 0 | 1 | 0 | 1 | 0 | 0 | 1 | 0 | 0 | 0 |
| #16 | 0 | 1 | 0 | 1 | 0 | 0 | 0 | 0 | 0 | 0 | 1 |
| #17 | 1 | 1 | 0 | 0 | 0 | 0 | 0 | 1 | 0 | 1 | 0 |
| #18 | 1 | 0 | 0 | 1 | 1 | 1 | 0 | 0 | 1 | 0 | 0 |
| #19 | 1 | 1 | 0 | 0 | 1 | 1 | 1 | 0 | 0 | 0 | 1 |
| #20 | 0 | 1 | 1 | 0 | 1 | 0 | 0 | 0 | 0 | 1 | 0 |
| #21 | 1 | 1 | 0 | 0 | 1 | 1 | 0 | 0 | 1 | 0 | 1 |
| #22 | 0 | 0 | 0 | 0 | 1 | 1 | 1 | 1 | 0 | 1 | 1 |
| #23 | 1 | 1 | 1 | 1 | 0 | 1 | 0 | 0 | 1 | 1 | 0 |
| #24 | 0 | 0 | 0 | 0 | 0 | 0 | 1 | 0 | 1 | 0 | 0 |
| #25 | 0 | 1 | 1 | 0 | 0 | 1 | 1 | 1 | 0 | 0 | 1 |
| #26 | 0 | 0 | 1 | 1 | 1 | 0 | 0 | 0 | 0 | 1 | 1 |
| #27 | 0 | 0 | 0 | 0 | 1 | 1 | 0 | 1 | 1 | 1 | 1 |
| #28 | 1 | 0 | 0 | 1 | 0 | 0 | 1 | 1 | 1 | 1 | 1 |
| #29 | 0 | 0 | 1 | 1 | 1 | 0 | 1 | 0 | 1 | 1 | 1 |
| #30 | 0 | 1 | 1 | 0 | 1 | 0 | 1 | 0 | 1 | 1 | 0 |

Each row of the new 31st-order square matrix, obtained in this method, makes up the mask sequence described above. That is, the rows of this matrix are mask sequences (M₁ to M₃₁) of length 31. These mask sequences are also linear codes. The 1st, 2nd, 3rd, 4th, and 5th rows (M₁, M₂, M₄, M₈, and M₁₆) of the matrix are basis codes of the mask sequences. More specifically, combination of the basis codes can represent any row of the matrix (i.e., all the mask sequences).

If the 31 rows of the square matrix are rearranged taking the basis codes into consideration, they can finally be expressed as in Table 7.

TABLE 7

| | | | | | | | | | | | | | | | | | | | | |
|---|---|---|---|---|---|---|---|---|---|---|---|---|---|---|---|---|---|---|---|---|
| M₁ | 1 | 1 | 0 | 1 | 1 | 1 | 1 | 0 | 0 | 0 | 0 | 0 | 1 | 1 | 0 | 0 | 0 | 1 | 1 | 0 |
| M₂ | 0 | 0 | 1 | 1 | 1 | 0 | 1 | 0 | 1 | 1 | 1 | 1 | 0 | 1 | 1 | 0 | 0 | 1 | 0 | 0 |
| M₃ | 1 | 1 | 1 | 0 | 0 | 1 | 0 | 0 | 1 | 1 | 1 | 1 | 1 | 0 | 1 | 0 | 0 | 0 | 1 | 0 |
| M₄ | 0 | 0 | 0 | 1 | 0 | 1 | 0 | 0 | 1 | 1 | 0 | 0 | 0 | 1 | 1 | 0 | 1 | 0 | 1 | 1 |
| M₅ | 1 | 1 | 0 | 0 | 1 | 0 | 1 | 0 | 1 | 1 | 0 | 0 | 1 | 0 | 1 | 0 | 1 | 1 | 0 | 1 |
| M₆ | 0 | 0 | 1 | 0 | 1 | 1 | 1 | 0 | 0 | 0 | 1 | 1 | 0 | 0 | 0 | 0 | 1 | 1 | 1 | 1 |
| M₇ | 1 | 1 | 1 | 1 | 0 | 0 | 0 | 0 | 0 | 0 | 1 | 1 | 1 | 1 | 0 | 0 | 1 | 0 | 0 | 1 |
| M₈ | 0 | 1 | 0 | 0 | 0 | 0 | 1 | 1 | 1 | 0 | 1 | 1 | 1 | 1 | 0 | 0 | 1 | 1 | 1 | 0 |
| M₉ | 1 | 0 | 0 | 1 | 1 | 1 | 0 | 1 | 1 | 0 | 1 | 1 | 0 | 0 | 0 | 0 | 1 | 0 | 0 | 0 |
| M₁₀ | 0 | 1 | 1 | 1 | 1 | 0 | 0 | 1 | 0 | 1 | 0 | 0 | 1 | 0 | 1 | 0 | 1 | 0 | 1 | 0 |
| M₁₁ | 1 | 0 | 1 | 0 | 0 | 1 | 1 | 1 | 0 | 1 | 0 | 0 | 0 | 1 | 1 | 0 | 1 | 1 | 0 | 0 |
| M₁₂ | 0 | 1 | 0 | 1 | 0 | 1 | 1 | 1 | 0 | 1 | 1 | 1 | 1 | 0 | 1 | 0 | 0 | 1 | 0 | 1 |
| M₁₃ | 1 | 0 | 0 | 0 | 1 | 0 | 0 | 1 | 0 | 1 | 1 | 1 | 0 | 1 | 1 | 0 | 0 | 0 | 1 | 1 |
| M₁₄ | 0 | 1 | 1 | 0 | 1 | 1 | 0 | 1 | 1 | 0 | 0 | 0 | 1 | 1 | 0 | 0 | 0 | 0 | 0 | 1 |
| M₁₅ | 1 | 0 | 1 | 1 | 0 | 0 | 1 | 1 | 1 | 0 | 0 | 0 | 0 | 0 | 0 | 0 | 0 | 1 | 1 | 1 |
| M₁₆ | 0 | 1 | 0 | 1 | 1 | 0 | 1 | 0 | 0 | 0 | 1 | 0 | 0 | 0 | 1 | 1 | 1 | 0 | 1 | 0 |
| M₁₇ | 1 | 0 | 0 | 0 | 0 | 1 | 0 | 0 | 0 | 0 | 1 | 0 | 1 | 1 | 1 | 1 | 1 | 1 | 0 | 0 |
| M₁₈ | 0 | 1 | 1 | 0 | 0 | 0 | 0 | 0 | 1 | 1 | 0 | 1 | 0 | 1 | 0 | 1 | 1 | 1 | 1 | 0 |
| M₁₉ | 1 | 0 | 1 | 1 | 1 | 1 | 1 | 0 | 1 | 1 | 0 | 1 | 1 | 0 | 0 | 1 | 1 | 0 | 0 | 0 |
| M₂₀ | 0 | 1 | 0 | 0 | 1 | 1 | 1 | 0 | 1 | 1 | 1 | 0 | 0 | 1 | 0 | 1 | 0 | 0 | 0 | 1 |
| M₂₁ | 1 | 0 | 0 | 1 | 0 | 0 | 0 | 0 | 1 | 1 | 1 | 0 | 1 | 0 | 0 | 1 | 0 | 1 | 1 | 1 |
| M₂₂ | 0 | 1 | 1 | 1 | 0 | 1 | 0 | 0 | 0 | 0 | 0 | 1 | 0 | 0 | 1 | 1 | 0 | 1 | 0 | 1 |
| M₂₃ | 1 | 0 | 1 | 0 | 1 | 0 | 1 | 0 | 0 | 0 | 0 | 1 | 1 | 1 | 1 | 1 | 0 | 0 | 1 | 1 |
| M₂₄ | 0 | 0 | 0 | 1 | 1 | 0 | 0 | 1 | 1 | 0 | 0 | 1 | 1 | 1 | 1 | 1 | 0 | 1 | 0 | 0 |
| M₂₅ | 1 | 1 | 0 | 0 | 0 | 1 | 1 | 1 | 1 | 0 | 0 | 1 | 0 | 0 | 1 | 1 | 0 | 0 | 1 | 0 |
| M₂₆ | 0 | 0 | 1 | 0 | 0 | 0 | 1 | 1 | 0 | 1 | 1 | 0 | 1 | 0 | 0 | 1 | 0 | 0 | 0 | 0 |
| M₂₇ | 1 | 1 | 1 | 1 | 1 | 1 | 0 | 1 | 0 | 1 | 1 | 0 | 0 | 1 | 0 | 1 | 0 | 1 | 1 | 0 |
| M₂₈ | 0 | 0 | 0 | 0 | 1 | 1 | 0 | 1 | 0 | 1 | 0 | 1 | 1 | 0 | 0 | 1 | 1 | 1 | 1 | 1 |
| M₂₉ | 1 | 1 | 0 | 1 | 0 | 0 | 1 | 1 | 0 | 1 | 0 | 1 | 0 | 1 | 0 | 1 | 1 | 0 | 0 | 1 |
| M₃₀ | 0 | 0 | 1 | 1 | 0 | 1 | 1 | 1 | 1 | 0 | 1 | 0 | 1 | 1 | 1 | 1 | 1 | 0 | 1 | 1 |
| M₃₁ | 1 | 1 | 1 | 0 | 1 | 0 | 0 | 1 | 1 | 0 | 1 | 0 | 0 | 0 | 1 | 1 | 1 | 1 | 0 | 1 |

| | | | | | | | | | | | |
|---|---|---|---|---|---|---|---|---|---|---|---|
| M₁ | 1 | 0 | 1 | 0 | 1 | 0 | 1 | 1 | 1 | 0 | 0 |
| M₂ | 0 | 0 | 1 | 1 | 0 | 1 | 1 | 1 | 0 | 0 | 0 |
| M₃ | 1 | 0 | 0 | 1 | 1 | 1 | 0 | 0 | 1 | 0 | 0 |
| M₄ | 1 | 1 | 1 | 1 | 1 | 0 | 0 | 1 | 0 | 0 | 1 |
| M₅ | 0 | 1 | 0 | 1 | 0 | 0 | 1 | 0 | 1 | 0 | 1 |
| M₆ | 1 | 1 | 0 | 0 | 1 | 1 | 1 | 0 | 0 | 0 | 1 |
| M₇ | 0 | 1 | 1 | 0 | 0 | 1 | 0 | 1 | 1 | 0 | 1 |
| M₈ | 1 | 0 | 0 | 1 | 0 | 0 | 0 | 1 | 0 | 1 | 1 |
| M₉ | 0 | 0 | 1 | 1 | 1 | 0 | 1 | 0 | 1 | 1 | 1 |
| M₁₀ | 1 | 0 | 1 | 0 | 0 | 1 | 1 | 0 | 0 | 1 | 1 |
| M₁₁ | 0 | 0 | 0 | 0 | 1 | 1 | 0 | 1 | 1 | 1 | 1 |
| M₁₂ | 0 | 1 | 1 | 0 | 1 | 0 | 0 | 0 | 0 | 1 | 0 |
| M₁₃ | 1 | 1 | 0 | 0 | 0 | 0 | 1 | 1 | 1 | 1 | 0 |
| M₁₄ | 0 | 1 | 0 | 1 | 1 | 1 | 1 | 1 | 0 | 1 | 0 |
| M₁₅ | 1 | 1 | 1 | 1 | 0 | 1 | 0 | 0 | 1 | 1 | 0 |
| M₁₆ | 0 | 1 | 0 | 1 | 1 | 1 | 0 | 1 | 1 | 1 | 0 |
| M₁₇ | 1 | 1 | 1 | 1 | 0 | 1 | 1 | 0 | 0 | 1 | 0 |
| M₁₈ | 0 | 1 | 1 | 0 | 1 | 0 | 1 | 0 | 1 | 1 | 0 |
| M₁₉ | 1 | 1 | 0 | 0 | 0 | 0 | 0 | 1 | 0 | 1 | 0 |
| M₂₀ | 1 | 0 | 1 | 0 | 0 | 1 | 0 | 0 | 1 | 1 | 1 |
| M₂₁ | 0 | 0 | 0 | 0 | 1 | 1 | 1 | 1 | 0 | 1 | 1 |
| M₂₂ | 1 | 0 | 0 | 1 | 0 | 0 | 1 | 1 | 1 | 1 | 1 |
| M₂₃ | 0 | 0 | 1 | 1 | 1 | 0 | 0 | 0 | 0 | 1 | 1 |
| M₂₄ | 1 | 1 | 0 | 0 | 1 | 1 | 0 | 0 | 1 | 0 | 1 |
| M₂₅ | 0 | 1 | 1 | 0 | 0 | 1 | 1 | 1 | 0 | 0 | 1 |
| M₂₆ | 1 | 1 | 1 | 1 | 1 | 0 | 1 | 1 | 1 | 0 | 1 |
| M₂₇ | 0 | 1 | 0 | 1 | 0 | 0 | 0 | 0 | 0 | 0 | 1 |
| M₂₈ | 0 | 0 | 1 | 1 | 0 | 1 | 0 | 1 | 1 | 0 | 0 |
| M₂₉ | 1 | 0 | 0 | 1 | 1 | 1 | 1 | 0 | 0 | 0 | 0 |
| M₃₀ | 0 | 0 | 0 | 0 | 0 | 0 | 1 | 0 | 1 | 0 | 0 |
| M₃₁ | 1 | 0 | 1 | 0 | 1 | 0 | 0 | 1 | 0 | 0 | 0 |

If a column of length 31, whose elements are all “0”, is inserted before the 1st column of the newly obtained square matrix, then it becomes a matrix of 31 rows and 32 columns. The rows of this matrix are mask sequences (M₁ to M₃₁) of length 32. The mask sequences are also linear codes. The 1st, 2nd, 4th, 8^{th}, and 16th rows (M₁, M₂, M₄, M₈, and M₁₆) of the matrix are basis codes of the mask sequences. That is, combination of the basis codes can represent any row of the matrix (i.e., all the mask sequences).

In the manner described above, the Walsh codes W and the mask sequences M are generated, and the basis codes (W₁, W₂, W₄, W₈, W₁₆, M₁, M₂, M₄, M₈, and M₁₆) of the generated Walsh codes W and the mask sequences M are determined as subcodes for encoding the header information. Accordingly, combination of the subcodes can express not only the 31 Walsh codes illustrated in FIG. 4 and the 31 mask sequences illustrated in FIG. 5, but can also express any combination of the Walsh codes and the mask sequences. Using the subcodes, it is possible for a receiver to reduce the calculation amount for decoding by using a correlator that employs an IFHT (Inverse Fast Hadamard Transform). The subcodes also show minimum distance characteristics better than the conventional 2nd-order Reed Muller codes.

2. Frame Structure

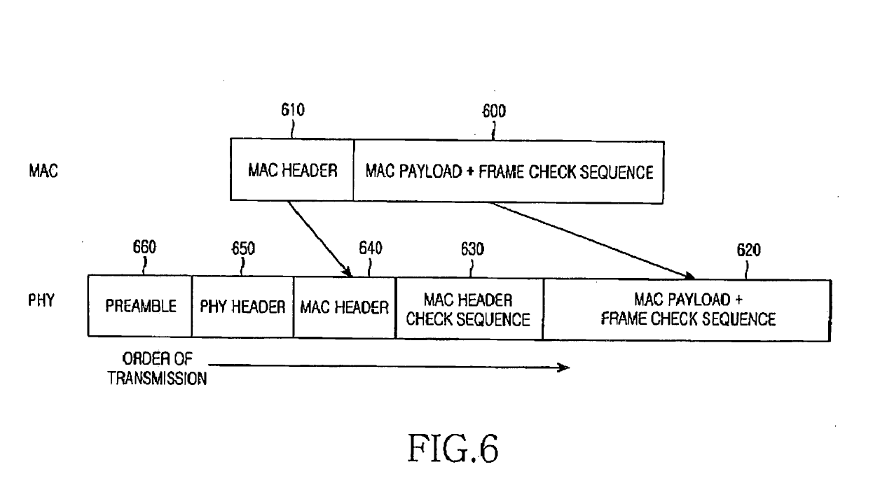

It is obvious that the frame structure employed in the conventional UWB communication system should be altered in order to implement the embodiments of the present invention. That is, to implement the embodiments of the present invention, it is required to provide a new definition of a header check sequence for error checking in PHY header information in the conventional frame structure. An example of the new definition is illustrated in FIG. 6. More specifically, FIG. 6 illustrates a new frame structure that can be proposed for the embodiments of the present invention. It can be seen from FIG. 6 that the new frame structure removes the conventional field 230 for transmission of the header check sequence, and newly defines a MAC header check sequence 630 for error checking of MAC header information.

As illustrated in FIG. 6, a MAC layer frame includes a MAC header 610 and a MAC payload+FCS (Frame Check Sequence) 600, and a PHY layer frame includes a preamble 660, a PHY header 650, a MAC header 640, the MAC header check sequence 630, and a MAC payload+FCS 620. The preamble 660 includes 160 symbols that can be obtained by repeating a CAZAC sequence of 16 symbols 10 times, which is used to achieve synchronization of signals, the recovery of carrier offset, the equalization of signals, etc.

According to the present invention, the PHY header 650 is comprised of 11 bits, rather than the 16 bits in the conventional frame. In more detail, the PHY header information recorded in the PHY header 650 includes 2-bit transfer rate information and 9-bit payload length information, in which the transfer rate information represents the transfer rate of a MAC frame required to recover signals in the PHY layer, and the payload length information represents the length of a payload. The PHY header information is transmitted after being encoded with an error-correcting code. The MAC header 640 carries information of a piconet ID, a transmission equipment ID, a reception equipment ID, etc., needed in the MAC layer. The MAC header check sequence 630 carries error check bits that enable a receiver to check errors in the header information that is transmitted through the MAC header 640.

In the prior art, the HCS portion is provided to transmit the header check sequence that informs whether an error occurs in the PHY and MAC headers. However, in the present invention, the PHY header information is protected by a subcode of 2nd-order Reed Muller code that is an error-correcting code. Therefore, if an error occurs in the PHY header, the error is corrected by using the error-correcting code, so that there is no need to transmit additional information for checking whether an error occurs in the PHY header. Accordingly, it is possible in the present invention that the conventional header check sequence for checking whether an error occurs in both the PHY header and the MAC header is replaced with a MAC header check sequence (error check bits) for checking whether an error occurs in only the MAC header. The error check bits generally use CRC bits. The MAC payload+FCS 620 carries a frame payload, which is target information for transmission, and a frame check sequence for checking whether an error occurs in the frame payload.

To generate such a frame, the MAC layer transfers a MAC payload+FCS 620, attached with a MAC header 610, down to the PHY layer. The PHY layer generates a MAC header check sequence 630 from the MAC header 610. Then, in the PHY layer, the MAC header check sequence 630 and a PHY header 650 are attached to the MAC header 640 and the MAC payload+FCS 620, received from the MAC layer, which are then transmitted after a preamble 660 is added thereto. The PHY header information transmitted by the PHY header 650, is encoded with the subcodes described above, which are error-correcting codes, to enable a receiver to perform error checking and correction of the PHY header information.

The major difference between the generated frame structure of the present invention and the conventional frame structure is how error checking and correction of the PHY header information is performed. That is, in the conventional frame structure, the PHY header information is subjected to only the error checking by using the error check bits (i.e., CRC bits) that are provided through the header check sequence 230. However, in the frame structure according to the present invention, the PHY header information is encoded with error-correcting codes so as to perform not only the error checking but also the error correction of the PHY header information.

In addition, the present invention adopts a coding rate of (32, 11) in encoding the PHY header information with the error-correcting code, and it is thus preferable that the PHY header information is composed of 11 bits. In the conventional frame, the PHY header information includes 2-bit seed information for a scrambler; 3-bit transfer rate information that represents a transfer rate and a modulation scheme of a MAC frame; and 11-bit payload length information that represents the length of a payload in octet units. That is, the PHY header information in the conventional frame is composed entirely of 16 bits. However, the present invention does not use the 2-bits for the seed information of the 16 bits of the conventional PHY header information. The present invention further proposes that the number of bits for the transfer rate information is reduced from 3 to 2, and the number of bits for the payload length information is reduced from 11 to 9. The adoption of the UWB communication system makes it possible to remove the 2-bit seed information, and also to represent the transfer rate information by only 2 bits because there are 3 kinds of transfer rate information in the UWB communication system. In the prior art, the payload length information is composed of 11 bits to represent the payload length in octet units. However, according to the present invention, it is possible to reduce the number of bits for the payload length information to 9 bits by representing it in 4-octet units.

3. Transmitter

A description will now be given of the configuration and operation of a transmitter for transmitting the header information after encoding it with the subcodes generated as described above. In the following embodiments according to the present invention, it is proposed that the transmitter uses PHY header information comprised of 11 bits and transmits the PHY header information after encoding the 11 bits, respectively, with 10 subcodes and one sequence. The purpose of using the single sequence is to extend error-correcting codes represented by the subcodes to bi-orthogonal codes.

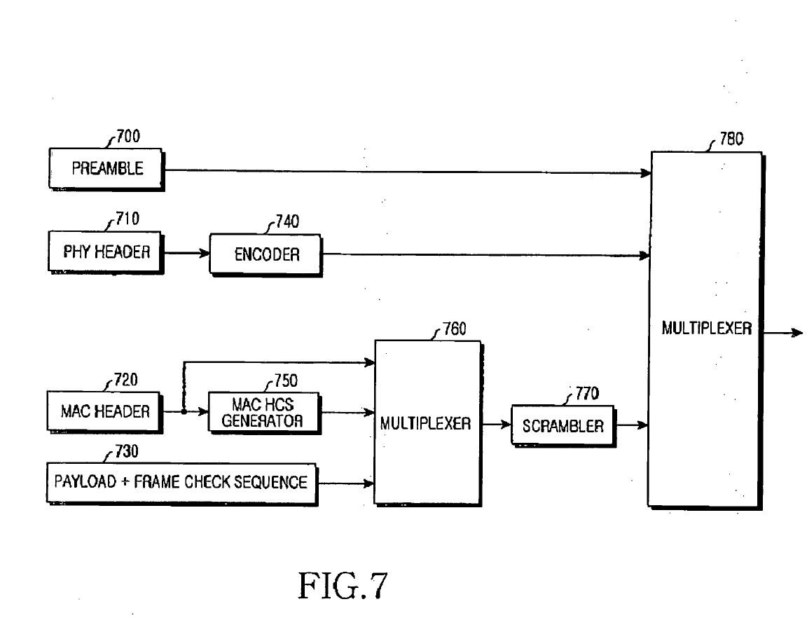

FIG. 7 is a block diagram showing the configuration of a transmitter in the UWB communication system, according to the embodiments of the present invention. As illustrated in FIG. 7, MAC header information 720 generated in the MAC layer is provided to a MAC header check sequence generator 750 and a multiplexer 760. The MAC header check sequence generator 750 generates a MAC header check sequence from the MAC header information. The MAC header check sequence is information for checking whether there is an error in the MAC header information, which may occur during the transmission. The MAC header check sequence generated by the MAC header check sequence generator 750 is provided to the multiplexer 760 through one input thereof.

A payload, which is target information for transmission, and a frame check sequence for informing whether an error occurs in the payload are provided to the multiplexer 760 through another input thereof. The payload, the frame check sequence, the MAC header information and the MAC header check sequence are multiplexed into a stream of information through the multiplexer 760, which is then output to a scrambler 770. The scrambler 770 scrambles the information stream with a predetermined scrambling code, and then outputs it to a multiplexer 780. The PHY header information 710, containing scrambling information used for the scrambling, is input to an encoder 740. The encoder 740 with a coding rate of (32,11) encodes the PHY header information with a predetermined error-correcting code and then outputs an encoded symbol stream of 32 symbols. The encoded symbol stream output from the encoder 740 is provided to the multiplexer 780 through one input thereof.

A preamble for achieving synchronization and channel estimation is provided to the multiplexer 780 through another input thereof. The multiplexer 780 temporally multiplexes the preamble, the encoded PHY header information, and the scrambled information, and then outputs them in a predetermined frame format.

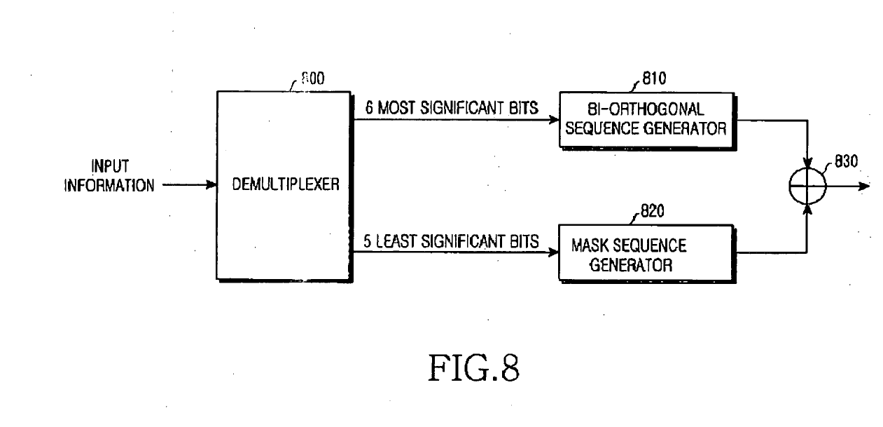

FIG. 8 is a block diagram conceptually illustrating an example of the configuration of the encoder illustrated in FIG. 7. As illustrated in FIG. 8, 11-bit input information (PHY header information) to be transmitted is output from a demultiplexer 800 after being separated into first header information bits and second header information bits by the demultiplexer 800. That is, the 11 bits of the input information are separated into 6 more significant bits corresponding to the first header information bits, and 5 less significant bits corresponding to the second header information bits. The first header information bits are input to a bi-orthogonal sequence generator 810, whereas the second header information bits are input to a mask sequence generator 820. The bi-orthogonal sequence generator 810 outputs one of 62 bi-orthogonal sequences that is indexed by the first header information bits. The 62 bi-orthogonal sequences include the 31 Walsh codes, generated as illustrated in FIG. 4, and 31 bi-orthogonal codes corresponding respectively to the 31 Walsh codes.

The mask sequence generator 820 outputs one of 31 mask sequences that is indexed by the second header information bits. These 31 mask sequences may be the mask sequences generated as illustrated in FIG. 5. The bi-orthogonal sequence from the bi-orthogonal sequence generator 810 and the mask sequence from the mask sequence generator 820 are exclusively Ored (XORed) with each other on a symbol-by-symbol basis through an exclusive OR element (or an exclusive logical adder) 830, which then outputs a stream of perfect or full encoded symbols (i.e., a PHY header information codeword) corresponding to the PHY header information bits. The stream of encoded symbols can be regarded as a subcode of 2nd-order Reed Muller code. The bi-orthogonal sequence generator 810 may have a coding table of bi-orthogonal sequences in correspondence with all possible cases of the first header information bits input to the generator 810. The mask sequence generator 820 may also have a coding table of mask sequences in correspondence with all possible cases of the second header information bits input to the generator 820.

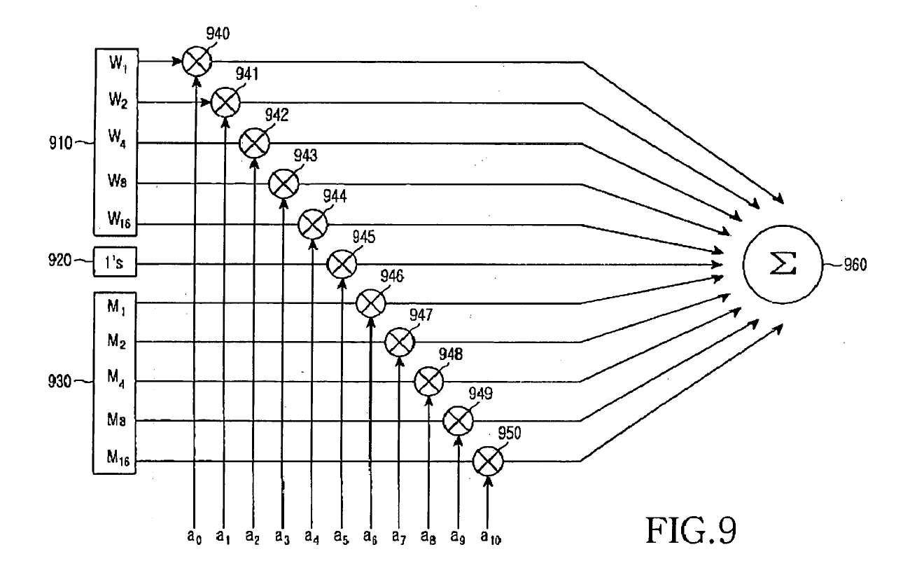

FIG. 9 illustrates an implementation example of the encoder illustrated in FIG. 8. As illustrated in FIG. 9, when the 11 PHY header information bits a₀, a₁, a₂, a₃, a₄, a₅, a₆, a₇, a₈, a₉, and a₁₀ are input to the encoder, they are input to AND elements (or logical multipliers) 940, 941, 942, 943, 944, 945, 946, 947, 948, 949, and 950, respectively. A basis Walsh code generator 910 generates a plurality of basis Walsh code sequences of length 32. The (logical) sum of at least two of the basis Walsh code sequences can generate all Walsh code sequences to be used. For example, if Walsh codes of length 32 are used, the basis Walsh codes are a first Walsh code W₁, a second Walsh code W₂, a fourth Walsh code W₄, an eighth Walsh code W₈, and a sixth Walsh code W₁₆. The first Walsh code W₁ is “01010101010101010101010101010101”; W₂ is “00110011001100110011001100110011”; W₄ is “00001111000011110000111100001111”; W₈ is “00000000000000001111111111111111”; and W₁₆ is “00000000000000001111111111111111”. A bit “1” generator 920 continually generates a sequence of specific symbol bits. That is, as the present invention is targeted to bi-orthogonal sequences, the generator 920 generates a bit sequence required to allow an orthogonal sequence to be used as bi-orthogonal sequences. For example, the bit “1” generator 920 continually generates a sequence of bits of “1”, so that orthogonal sequences (Walsh code sequences) generated from the basis Walsh code generator 910 are inversed to generate bi-orthogonal sequences. The basis mask sequence generator 930 generates a plurality of basis mask sequences of length 32. For example, if mask sequences of length 32 are used, the basis mask sequences are a first mask sequence M₁, a second mask sequence M₂, a fourth mask sequence M₄, an eighth mask sequence M₈, and a sixth mask sequence M₁₆. The first mask sequence M₁ is “01101111000001100011010010011100”; M₂ is “00011101011110110010000110111000”; M₄ is “00001010011000110101111111001001”; M₈ is “00100001110111100111010010001011”; and M_{16 is “}00101101000100011101001011101110”.

The basis Walsh code sequences W₁, W₂, W₄, W₈, and W₁₆ output from the basis Walsh code generator 910 are input to the AND element 940, 941, 942, 943, and 944, respectively. The AND element 940 outputs a logical product of the input first basis Walsh code W₁ and the first bit a₀ of the PHY header information bits, and the AND element 941 outputs a logical product of the input W₂ and the bit a₁ of the PHY header information bits. Further, the AND element 942 outputs a logical product of the input code W₄ and the bit a₂ of the PHY header information bits, and the AND element 943 outputs a logical product of the input W₈ and the bit a₃ of the PHY header information bits. Finally, the AND element 944 outputs a logical product of the input W₁₆ and the bit a₄ of the PHY header information bits.

To output the logical product, each of the AND elements 940, 941, 942, 943, and 944 performs an AND operation on a symbol-by-symbol basis between a corresponding one of the codes W₁, W₂, W₄, W₈, and W₁₆ and a corresponding one of the PHY header information bits. A symbol “1” output from the bit “1” generator 920 is input to an AND element 945, which outputs a logical product of the input symbol “1” and the bit a₅ of the PHY header information bits on a symbol-by-symbol basis. However, the basis mask sequences M₁, M₂, M₄, M₈, and M₁₆ output from the basis mask sequence generator 930 are input to the AND elements 946, 947, 948, 949, and 950, respectively. The AND element 946 outputs a logical product of the input first basis mask sequence M₁ and the sixth bit a₆ of the PHY header information bits, and the AND element 947 outputs a logical product of the input M₂ and the bit a₇ of the PHY header information bits. Further, the AND element 948 outputs a logical product of the input M₄ and the bit a₈ of the PHY header information bits, and the AND element 949 outputs a logical product of the input M₈ and the bit a₉ of the PHY header information bits. Finally, the AND element 950 outputs a logical product of the input M₁₆ and the bit a₁₀ of the PHY header information bits.

To output the logical product, each of the AND elements 946, 947, 948, 949, and 950 performs an AND operation on a symbol-by-symbol basis between a corresponding one of the codes M₁, M₂, M₄, M₈, and M₁₆ and a corresponding one of the PHY header information bits.

The encoded PHY header information bits output from the AND elements 940 to 950 are input to an exclusive OR element 960, whereby they are exclusively ORed together on a symbol-by-symbol basis to output a sequence of encoded symbols. Accordingly, the exclusive OR element 960 outputs final encoded symbols (a PHY header information codeword) having a length of 32 bits. As described above, the length of the final encoded symbols from the exclusive OR element 960 is determined based on the length of the basis Walsh codes and the basis mask sequences, generated respectively from the basis Walsh code generator 910 and the basis mask sequence generator 930.

A description will now be given of an example of the operation of the encoder illustrated in FIG. 9 in the case where the input PHY header information bits a₀ to a₁₀ are “01110110001”. In this example, a bit “0” corresponding to a₀ is ANDed with the code W₁ generated from the basis Walsh code generator 910 on a symbol-by-symbol basis at the AND element 940, which then outputs corresponding encoded symbols of length 32 (all “0”). A bit “1” corresponding to a₁ is ANDed with the code W₂ generated from the basis Walsh code generator 910 on a symbol-by-symbol basis at the AND element 941, which then outputs corresponding encoded symbols “00110011001100110011001100110011”. A bit “1” corresponding to a₂ is ANDed with the code W₄ generated from the basis Walsh code generator 910 on a symbol-by-symbol basis at the AND element 942, which then outputs corresponding encoded symbols “00001111000011110000111100001111”. A bit “1” corresponding to a₃ is ANDed with the code W₈ generated from the basis Walsh code generator 910 on a symbol-by-symbol basis at the AND element 943, which then outputs corresponding encoded symbols “00000000111111110000000011111111”. A bit “0” corresponding to a₄ is ANDed with the code W₁₆ generated from the basis Walsh code generator 910 on a symbol-by-symbol basis at the AND element 944, which then outputs corresponding encoded symbols of length 32 (all “0”).

A bit “1” corresponding to a₅ is ANDed with a bit “1” generated from the bit “1” generator 920 on a symbol-by-symbol basis at the AND element 945, which then outputs corresponding encoded symbols of length 32 (all “1”). A bit “1” corresponding to a₆ is ANDed with the sequence M₁ generated from the basis mask sequence generator 930 on a symbol-by-symbol basis at the AND element 946, which then outputs corresponding encoded symbols “01101111000001100011010101011100”. A bit “0” corresponding to a₇ is ANDed with the sequence M₂ generated from the basis mask sequence generator 930 on a symbol-by-symbol basis at the AND element 947, which then outputs corresponding encoded symbols of length 32 (all “0”). A bit “0” corresponding to a₈ is ANDed with the sequence M₄ generated from the basis mask sequence generator 930 on a symbol-by-symbol basis at the AND element 948, which then outputs corresponding encoded symbols of length 32 (all “0”). A bit “0” corresponding to a₀ is ANDed with the sequence M₈ generated from the basis mask sequence generator 930 on a symbol-by-symbol basis at the AND element 949, which then outputs corresponding encoded symbols of length 32 (all “0”).

Finally, a bit “1” corresponding to a₁₀ is ANDed with the sequence M₁₆ generated from the basis mask sequence generator 930 on a symbol-by-symbol basis at the AND element 950, which then outputs corresponding encoded symbols “00101101000100011101001011101110”. The sequences of encoded symbols output from the AND elements 940 to 950 are input to the exclusive OR element 960, whereby they are exclusively ORed together on a symbol-by-symbol basis to output a final sequence of encoded symbols “10000001001010110010010010001110”. These final encoded symbols are the same as the symbol-by-symbol exclusive OR of the basis Walsh codes W₂, W₄, and W₈, a sequence of Is from the generator 920, and the basis mask sequences M₁ and M₁₆, which correspond to the input information bits of “1” (i.e., a₁, a₂, a₃, a₅, a₆, and a₁₀). In other words, the basis Walsh code W₂, W₄, and W₈ are exclusively ORed together to produce a Walsh code W₁₄, and then a bi-orthogonal Walsh code (\overline{W}₁₄) corresponding to the generated code W₁₄ and the two mask sequences M₁ and M₁₆ are exclusively ORed together (i.e., \overline{W}₁₄⊕M₁⊕M₁₆) to produce encoded symbols, which are finally output, as a PHY header information codeword, from the exclusive OR element 960.

4. Receiver

A detailed description will now be given of the configuration and operation of a receiver for decoding header information that was encoded and transmitted as described above. In the following embodiment according to the present invention, it is proposed that the receiver uses PHY header information comprised of 11 bits and it is assumed that the 11 PHY header information bits are encoded with a coding rate of (32, 11).

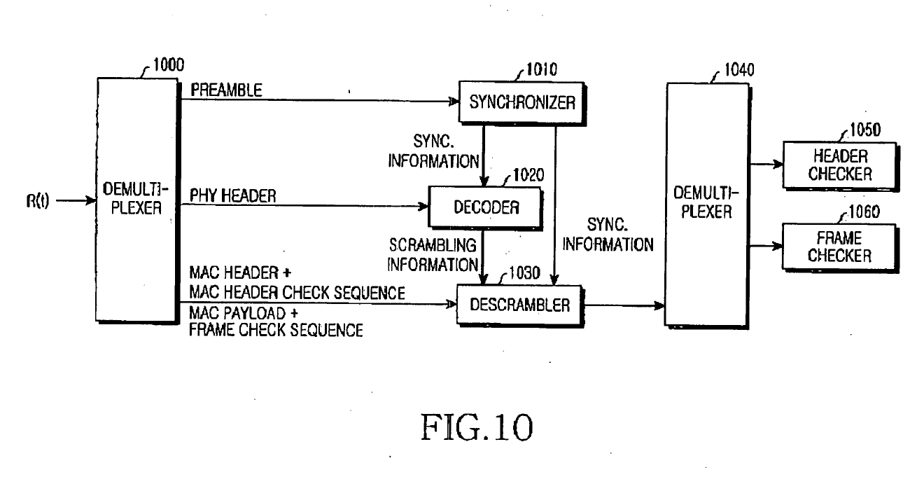

FIG. 10 is a block diagram illustrating the configuration of a receiver in a UWB communication system according to an embodiment of the present invention. As illustrated in FIG. 10, a received signal R(t), transmitted from a transmitter in a UWB communication system, is input to a demultiplexer 1000. The demultiplexer 1000 separates the received signal R(t) into a preamble, PHY header information, and the other information. The preamble is provided to a synchronizer 1010, which then performs both a synchronization operation and a channel estimation operation on the basis of the preamble. The synchronizer 1010 outputs synchronization information obtained by the synchronization operation. As it has been encoded with a predetermined error-correcting code, the PHY header information is provided to a decoder 1020 for decoding. The decoder 1020 receives the synchronization information from the synchronizer 1010, and decodes and outputs the PHY header information. As the PHY header information contains scrambling information regarding a scrambling code used in the transmitter, the decoder 1020 outputs the scrambling information contained in the PHY header information. The remaining information of the received signal R(t), other than the preamble and the PHY header information, is provided to a descrambler 1030. That is, the remaining information of the received signal R(t), combining a MAC header, a MAC header check sequence, a payload, and a frame check sequence together, from which the preamble and the PHY header information are removed, is provided to the descrambler 1030. The descrambler 1030 receives the synchronization information and the scrambling information respectively from the synchronizer 1010 and the decoder 1020, and descrambles the remaining information with a scrambling code according to the scrambling information, and then outputs the descrambled information.

The information descrambled by the descrambler 1030 is provided to a demultiplexer 1040. The descrambler 1040 separates the information from the demultiplexer 1040 into a MAC header check sequence and a frame check sequence, and outputs the separated sequences. The MAC header check sequence is provided to a header checker 1050, whereas the frame check sequence is provided to a frame checker 1060. Based on the MAC header check sequence, the header checker 1050 checks whether an error occurs in the MAC header information provided from the descrambler 1030, and outputs the checked result. For example, the header checker 1050 performs error checking based on CRC bits. Based on the frame check sequence, the frame checker 1060 checks whether an error occurs in the payload provided from the descrambler 1030, and outputs the checked result.

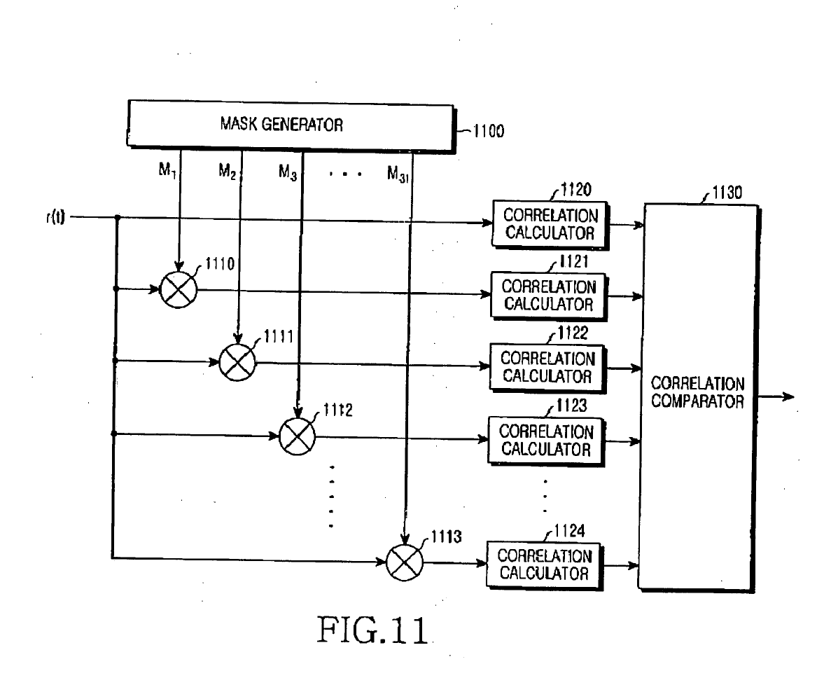

FIG. 11 is a block diagram illustrating a detailed example of the decoder 1020 illustrated in FIG. 10. As illustrated in FIG. 11, a received signal r(t) is input to a correlation calculator 1120, and 31 AND elements 1110, 1111, 1112, . . . , 1113. The received signal r(t) is the PHY header information output from the demultiplexer 1000 in FIG. 10, where the PHY header information has been encoded with predetermined error-correcting codes in the transmitter, as described above. In other words, the received signal r(t) is a signal that has been encoded with predetermined mask sequences, a sequence of 1s, and predetermined Walsh codes in the transmitter.

A mask sequence generator 1100 generates 31 mask sequences M₁, M₂, M₃, . . . , M₃₁, and outputs them to the 31 AND elements 1110, 1111, 1112, . . . , and 1113, respectively. These 31 mask sequences M₁, M₂, M₃, . . . , and M₃₁ are the same as the mask sequences used in the transmitter.

The 31 AND elements 1110, 1111, 1112, . . . , and 1113 perform respective AND operations between the received signal r(t) and the 31 inherent mask sequences from the mask sequence generator 1100, and output the operation result. That is, the AND element 1110 performs an AND operation between the received signal r(t) and the mask sequence M₁ from the mask sequence generator 1100, and outputs the operation result to acorrelation calculator 1121. The AND element 1111 performs an AND operation between the received signal r(t) and the mask sequence M₂ from the mask sequence generator 1100, and outputs the operation result to a correlation calculator 1122. The AND element 1112 performs an AND operation between the received signal r(t) and the mask sequence M₃ from the mask sequence generator 1100, and outputs the operation result to a correlation calculator 1123. The AND element 1113 performs an AND operation between the received signal r(t) and the mask sequence M₃₂ from the mask sequence generator 1100, and outputs the operation result to a correlation calculator 1124. Accordingly, if the PHY header information bits have been encoded by combination of basis mask sequences in the transmitter, one of the outputs from the AND elements 1110, 1111, 1112, . . . , and 1113 will be a signal from which the mask sequence is removed. For example, if the PHY header information bits have been encoded with a mask sequence M₂ in the transmitter, the output of the AND element 1111, performing an AND operation of the received signal r(t) and the inherent mask sequence M₂, will be a signal from which the mask sequence is removed. The signal from which the mask sequence is removed is a signal of PHY header information bits encoded only with predetermined Walsh codes. The correlation calculators 1120, 1121, 1122, 1123, and 1124 receive 32 signals (i.e., the received signal r(t) and the 31 outputs from the 31 AND elements 1110, 1111, 1112, . . . , and 1113) through their respective inputs, and calculate respective correlation values between each of the 62 bi-orthogonal Walsh codes and the 32 received signals. As defined above, the 62 bi-orthogonal Walsh codes are all Walsh codes that can be produced by combination of basis Walsh codes and a sequence of 1s.

More specifically, the correlation calculator 1120 obtains 62 respective correlation values between the received signal r(t) and the 62 bi-orthogonal Walsh codes of length 32. The correlation calculator 1120 then determines a largest one of the 62 correlation values. The correlation calculator 1120 outputs a Walsh code index corresponding to the determined correlation value, an inherent index of the correlation calculator 1120, and the determined correlation value to a correlation comparator 1130. The correlation calculator 1120 outputs “0” as the inherent index, since no AND operation has been performed with a specific mask sequence at the previous stage. The correlation calculator 1121 calculates 62 respective correlation values between the output from the AND element 1110 and 62 bi-orthogonal Walsh codes of length 32. The correlation calculator 1121 then determines a largest one of the 62 correlation values. The correlation calculator 1121 outputs a Walsh code index corresponding to the determined correlation value, an inherent index of the correlation calculator 1121, and the determined correlation value to the correlation comparator 1130. The inherent index output from the correlation calculator 1121 will be “1”. The correlation calculator 1122 calculates 62 respective correlation values between the output from the AND element 1111 and 62 bi-orthogonal Walsh codes of length 32. The correlation calculator 1122 then determines a largest one of the 62 correlation values. The correlation calculator 1122 outputs a Walsh code index corresponding to the determined correlation value, an inherent index of the correlation calculator 1122, and the determined correlation value to the correlation comparator 1130. The inherent index output from the correlation calculator 1122 will be “2”. The correlation calculator 1123 calculates 62 respective correlation values between the output from the AND element 1112 and 62 bi-orthogonal Walsh codes of length 32. The correlation calculator 1123 then determines a largest one of the 62 correlation values. The correlation calculator 1123 outputs a Walsh code index corresponding to the determined correlation value, an inherent index of the correlation calculator 1123, and the determined correlation value to the correlation comparator 1130. The inherent index output from the correlation calculator 1123 will be “3”. Finally, the correlation calculator 1124 calculates 62 respective correlation values between the output from the AND element 1113 and 62 bi-orthogonal Walsh codes of length 32. The correlation calculator 1124 then determines a largest one of the 62 correlation values. The correlation calculator 1124 outputs a Walsh code index corresponding to the determined correlation value, an inherent index of the correlation calculator 1124, and the determined correlation value to the correlation comparator 1130. The inherent index output from the correlation calculator 1124 will be “31”.

As described above, the inherent indices output from the correlation calculators 1120, 1121, 1122, 1123, . . . , and 1124 are the same as the indices for discriminating the predetermined mask sequences that have been subjected to the AND operations by the AND elements 1110, 1111, 1112, . . . , and 1113. The correlation calculators employ IFHT (Inverse Fast Hadamard Transform) for speedy calculation of correlation with all Walsh codes.

The correlation comparator 1130 compares the 32 largest correlation values received respectively from the 32 correlation calculators 1120, 1121, 1122, 1123, . . . , and 1124, and determines a largest one of the 32 largest correlation values. After determining the largest correlation value, the correlation comparator 1130 outputs PHY header information bits transmitted from the transmitter on the basis of a mask sequence index and a Walsh code index provided from a correlation calculator in correlation with the determined largest correlation value. The PHY header information bits may be determined according to the Walsh code index and the mask sequence index by combining the two indices. In other words, if it is assumed that the mask sequence index is an index corresponding to M₄ and the Walsh code index is an index corresponding to W₄, the PHY header information bits will be decoded as “Index corresponding to M₄+Index corresponding to W₄”.

For example, if it is assumed that “01101010100” as PHY header information bits (a₀ to a₁₀) have been encoded and transmitted by the transmitter, the PHY header information bits will have been transmitted after being encoded with W₂₂ and M₅ in the transmitter. A description thereof has already been given above with reference to the operation of the encoder. Otherwise, by performing respective AND operations between the received signal r(t) encoded with W₂₂ and M₅ and all the mask sequences, the receiver recognizes that the PHY header information bits have been encoded with M₅. Further, by measuring correlations between all the Walsh codes and the received signal r(t), which has been subjected to an AND operation with the mask sequence M₅, the receiver recognizes that the received signal r(t) has been encoded with W₂₂. After learning that the received signal r(t) has been encoded with W₂₂ and M₅, the receiver combines “011010” (an index corresponding to W₂₂) with “10100” (an index corresponding to M₅) to output “01101010100” as the decoded PHY header information bits.

As is apparent from the above description, the present invention provides an apparatus and method for transmitting header information in a UWB communication system, in which a code with good minimum distance characteristics, selected from 2nd-order Reed Muller codes, is proposed as a new subcode, and the subcode is used as an error-correcting code to protect a PHY header in WPAN environments. The subcode of 2nd-order Reed Muller code proposed in the present invention is advantageous in that it makes it possible to use a soft decision decoder and to perform decoding with a smaller number of calculations by using an IFHT decoder. Also, the subcode of 2nd-order Reed Muller code proposed in the present invention has good minimum distance characteristics. Therefore, using the subcode of 2nd-order Reed Muller code of (32, 11) allows correction of errors in important data that occur in the course of receiving a PHY header or the like, which improves the throughput and decreases the bit error rate, thus improving the reliability.

Although the preferred embodiments of the present invention have been disclosed for illustrative purposes, those skilled in the art will appreciate that various modifications, additions and substitutions are possible, without departing from the scope and spirit of the present invention as disclosed in the accompanying claims.

What is claimed is:

1. An apparatus for decoding in a receiver physical layer header information symbols, which have been encoded with a coding rate of (2^{k}, 2^{k+}1) and transmitted through a frame having physical layer header information, in an ultra wide band (UWB) communication system in which a plurality of devices have the receiver constitute a piconet and data transmission between the plurality of devices is performed through the frame, said apparatus comprising:
a mask sequence generator for generating (2^{k}−1) mask sequences, each having an inherent mask sequence index;
a plurality of AND elements for receiving the mask sequences and an encoded physical layer header information symbol sequence of length 2^{k} as inputs, performing AND operations respectively between the mask sequences and the encoded physical layer header information symbol sequence, and outputting physical layer header information symbol sequences from which the mask sequences are removed;
a plurality of correlation calculators for receiving the encoded physical layer header information symbol sequence and the physical layer header information symbol sequences from which the mask sequences are removed, calculating correlation values respectively between a corresponding one of the symbol sequences and a plurality of bi-orthogonal Walsh codes, each code having an inherent Walsh code index, and outputting a largest one of the calculated correlation values, a corresponding mask sequence index, and a Walsh code index corresponding to the largest correlation value; and
a correlation comparator for comparing the correlation values output respectively from the plurality of correlation calculators, combining together a Walsh code index and a mask sequence index, both corresponding to a largest one of the compared correlation values, and outputting the combined indices as (2 k+1)-bit physical layer header information.

2. The apparatus according to claim 1, wherein the physical layer header information is information of a MAC frame's transfer rate, data length, and a scrambling code used in the transmitter.

3. The apparatus according to claim 1, wherein the value of k is 5.

4. A method for decoding in a receiver physical layer header information symbols, which have been encoded with a coding rate of (2^{k}, 2 k+1) and transmitted through a frame having physical layer header information, in an ultra wide band (UWB) communication system in which a plurality of devices have the receiver constitute a piconet and data transmission between the plurality of devices is performed through the frame, said method comprising the steps of:
a) generating (2^{k}−1) mask sequences, each having an inherent mask sequenceindex;
b) receiving, as inputs, the mask sequences and an encoded physical layer header information symbol sequence of length 2^{k};
c) performing AND operations respectively between the mask sequences and the encoded physical layer header information symbol sequence;
d) outputting physical layer header information symbol sequences from which the mask sequences are removed;
e) receiving, as inputs, the encoded physical layer header information symbol sequence and the physical layer header information symbol sequences from which the mask sequences are removed;
f) calculating correlation values respectively between each of the symbol sequences and a plurality of bi-orthogonal Walsh codes, each code having an inherent Walsh code index;
g) outputting, for each of the symbol sequences, a largest one of the calculated correlation values, a corresponding mask sequence index, and a Walsh code index corresponding to the largest correlation value; and
h) comparing the output correlation values corresponding respectively to the symbol sequences; combining together a Walsh code index and a mask sequence index, both corresponding to a largest one of the compared correlation values; and
i) outputting the combined indices as (2 k+1)-bit physical layer header information.

5. The method according to claim 4, wherein the physical layer header information is information of a MAC frame's transfer rate, data length, and a scrambling code used in the transmitter.

6. The method according to claim 4, wherein the value of k is 5.

7. A frame structure for transmitting data in an ultra wide band (UWB) communication system, said frame structure comprising: at least one section of physical layer header information that is encoded with an error-correcting code.

8. The frame structure according to claim 7, wherein the error-correcting code is a 2nd-order Reed Muller code.

9. An apparatus for protecting and transmitting by a transmitter physical layer header information of respective header information of layers, in an ultra wide band (UWYB) communication system in which a plurality of devices have the transmitter constitute a piconet and data transmission between the plurality of devices is performed through a frame having said respective header information of the layers, said apparatus comprising:
a bi-orthogonal sequence generator for generating a bi-orthogonal sequence by performing an AND operation between more significant bits of physical layer header information bits and predetermined basis Walsh code sequences;
a mask sequence generator for generating a mask sequence by performing an AND operation between less significant bits of the physical layer header information bits and predetermined mask sequences; and
an exclusive OR element for performing an exclusive OR operation on a symbol-by-symbol basis between the bi-orthogonal sequence output from the bi-orthogonal sequence generator and the mask sequence output from the mask sequence generator, so as to output a single encoded symbol sequence.

10. The apparatus according to claim 9, wherein the physical layer header information bits are 11 bits in length.

11. The apparatus according to claim 10, wherein the physical layer header information bits include information of a MAC frame's transfer rate and information of a payload length.

12. The apparatus according to claim 9, wherein the bi-orthogonal sequence generator comprises:
a bit “1” generator for generating a sequence of 1s;
a basis Walsh code generator for generating 5 basis Walsh code sequences of length 32; and
a plurality of AND elements for receiving all 11 bits of the physical layer header information as their inputs, performing respective AND operations between 5 more significant bits of the 11 bits and the 5 basis Walsh code sequences, and performing an AND operation between a sixth bit of the 11 bits and the sequence of 1s.

13. The apparatus according to claim 9, wherein the mask sequence generator comprises:
a basis mask sequence generator for generating 5 basis mask sequences of length 32; and
a plurality of AND elements for receiving all 11 bits of the physical layer header information as their inputs, and performing respective AND operations between 5 less significant bits of the 11 bits and the 5 basis mask sequences.

14. A method for protecting and transmitting by a transmitter physical layer header information, of respective header information of layers, in an ultra wide band (UWB) communication system in which a plurality of devices have the transmitter constitute a piconet and data transmission between the plurality of devices is performed through a frame having said respective header information of the layers, said method comprising the steps of:
a) generating a bi-orthogonal sequence by performing an AND operation between more significant bits of physical layer header information bits and predetermined basis Walsh code sequences;
b) generating a mask sequence by performing an AND operation between less significant bits of the physical layer header information bits and predetermined mask sequences;
c) performing an exclusive OR operation on a symbol-by-symbol basis between the generated bi-orthogonal sequence and the generated mask sequence, and
d) outputting a single encoded symbol sequence.

15. The method according to claim 14, wherein the physical layer header information bits are 11 bits in length.

16. The method according to claim 15, wherein the physical layer header information bits include information of a MAC frame's transfer rate and information of a payload length.

17. The method according to claim 14, wherein said step a) comprises the steps of:
a-1) generating a sequence of 1s;
a-2) generating 5 basis Walsh code sequences of length 32;
a-3) receiving, as inputs, all 11 bits of the physical layer header information;
a-4) performing respective AND operations between 5 more significant bits of the 11 bits and the 5 basis Walsh code sequences; and
a-5) performing an AND operation between a sixth bit of the 11 bits and the sequence of 1s.

18. The method according to claim 14, wherein said step b) comprises the steps of:
b-1) generating 5 basis mask sequences of length 32;
b-2) receiving, as inputs, all 11 bits of the physical layer header information; and
b-3) performing respective AND operations between 5 less significant bits of the 11 bits and the 5 basis mask sequences.
